(19) United States
(12) Patent Application Publication
(10) Pub. No.: US 2002/0036569 A1
(43) Pub. Date: Mar. 28, 2002

(54) Tag and receiver systems

(76) Inventor: Philip John Martin, Tonbridge (GB)

Correspondence Address: Philip John Martin, 6, The Manwarings, Horsmonden, Tonbridge, TN12 8NQ, GB

(21) Appl. No.: 09/921,552

(22) Filed: Aug. 6, 2001

Related U.S. Application Data
(60) Provisional application No. 60/225,744, filed on Aug. 17, 2000.

(30) Foreign Application Priority Data
Aug. 14, 2000 (GB) 0019958.8
Jan. 22, 2001 (GB) 0101580.9
Jun. 8, 2001 (GB) 0113998.9

(51) Int. Cl. G08B 23/00

(52) U.S. Cl. 340/573.1; 340/572.1

(57) ABSTRACT

A pet tag (10) for locating lost pets, the tag comprising a housing containing an internal power supply and a micropower rf transmitter (26) to transmit a spread spectrum signal such as a Gold or Kasami coded signal; and an optional acoustic command receiver (20) to receive an acoustic command; and wherein the coded signal is transmitted in response to reception of an acoustic command.

A corresponding detector (1200) for locating a tagged pet comprises: a direct sequence spread spectrum (DSSS) receiver (1300) for receiving from the tag a spread spectrum signal based on a Gold or Kasami code; a first aerial (1206) coupled to the receiver; input means (1210) for user selection of a said Gold or Kasami code; and indicating means (1228) for indicating when a tag with the selected code is detected.

### FIELD OF THE INVENTION

This invention generally relates to tag and receiver systems suitable for locating lost objects and for alerting a user to separation from a tagged object. The invention is particularly suitable for locating lost pets and for reducing the risk of losing valuables, but it can also be used, for example, for locating lost people and objects such as lost files.

### BACKGROUND TO THE INVENTION

Both cats and dogs are apt to stray and the loss of a pet is a distressing experience for both the pet and its owner. Finding for a lost pet is difficult, especially where the animal may have become trapped, and sometimes the pet is never recovered. On the face of it, it would appear to be an easy task to simply fit some form of electronic tagging device to a pet so that it could be tracked and located should it go missing. However in practice there are technical problems which make a feasible solution extremely difficult to achieve. These problems mainly relate to providing a tag of a sufficiently small size to be attached to a pet without discomfort, whilst at the same time providing a useful transmit range combined with low enough power consumption to provide sufficient time for the tagged pet to be located, preferably at least a few hours, preferably without the need to change the batteries too frequently.

Electronic tagging devices are known for preventing theft of items from shops. However, although these tags are small and cheap, they can only be detected at relatively short ranges, typically a couple of meters. Security tags which transmit coded information in response to an interrogation signal are also known for identifying pets and also items such as antiques. However, again these tags can only be detected at very short ranges, typically a few centimeters. It is possible to conceive of tags with increased ranges, for example using a simple, battery-powered radio frequency transmitter, but to achieve ranges of more than a few meters requires a significant transmitter output power. However, the transmitter and the batteries required to power it even for a few hours would be too large to be easily carried by a small domestic pet, and even with careful, low-power design it would be difficult to achieve a battery-change interval of more than a day or two from batteries ordinarily used for portable electronic devices.

A related problem, involving some of the same considerations, concerns preventing loss of a tagged object in the first place. The tagged object could be a pet, child or old person or some other object. For example, it is commonplace for goods to be left behind on trains and other forms of transport, and in places of entertainment. Sometimes documents or computers are lost and where valuable goods have been lost frequently they are never retrieved. It is therefore desirable to be able to provide a warning when an object is about to be left behind or lost.

The object to be protected may be provided with a tag transmitting a signal to a receiver carried by, or in close proximity to, the object's owner, bearer or guardian. When the tag goes out of range of the receiver it may be assumed that the tagged object has been separated from its owner and is in danger of being forgotten or lost. However, two problems arise with such a simple arrangement. Firstly, since the tag is always transmitting the lifetime of a battery powering the tag can be expected to be relatively short. Secondly, it is desirable to be able to distinguish between accidental impending loss and deliberate abandoning of the object, for example, when the owner deliberately wishes to leave the tagged object behind.

There thus exists a need for improved tags, receivers and tag and receiver systems suitable for, among other things, inhibiting loss of and locating domestic pets and other objects.

A tag for locating lost pets should be small enough to be easily carried by the pet, which could be a small cat, and yet provide a range of at least 10 m and a quiescent battery life of, preferably, more than 1 month. A 10 m range is sufficient to provide considerable assistance in searching for a lost cat, although a greater range is desirable for larger pets such as dogs. A further requirement is that the tag at least should be affordable. The detection equipment, which is likely to be needed only infrequently, could if necessary be hired rather than purchased so that the receiver cost, whilst important, is a less significant factor.

A tag for inhibiting loss of other types of object should also be relatively small, but need only have a range of a few meters, for example 1 m to 5 m. Similarly although a long quiescent battery life is desirable this is not essential as the tag may be installed in portable electronic equipment, such as a laptop computer, which has a power supply and/or which is frequently connected to the mains supply.

A pet owner will want to be able to identify and locate his or her particular pet. Furthermore, since a geographical locality may contain more than one tagged pet the system should preferably be able to distinguish between signals from two or more different tags in order to be able to determine and identifying code for each tag. It is not necessary, however, to uniquely identify each animal providing an owner can be reasonably confident that it is their pet they are locating.

A different but related set of problems is encountered when wishing to locate lost files. Since files are generally stored together, a system for locating a lost file must be able to distinguish the signal of one file from those of its neighbours. Generally speaking there likely to be many more different files in any single place than pets. Thus a greater distinguishing capability is required. However, it will normally be possible to operate a file locating system with the detector less than im from the tagged files, so that range is less important. A small physical size and a long battery life are probably more important requirements and, where many thousands of files are to be tagged, it is important that the tag cost is minimised.

A system for tracking objects in a semiconductor fabrication facility using spread spectrum tags with a unique ID is known from U.S. Pat. No. 5,119,104. A system for confining animals using spread spectrum transmissions is described in U.S. Pat. No. 5,769,032. A spread spectrum signal is transmitted to a receiver on the animal's collar and the signal strength is used to determine whether the animal is near a boundary.

A CDMA spread spectrum asset tracking system is described on the web site of the UK Radiocommunications Agency. This briefly alludes to a transponder comprising a 0.1 W spread spectrum transmitter, a microcontroller and a paging-type receiver for commands. The transponder is located by time-of-arrival measurements using multiple base stations and a control/processing site using hyperbolic navigation techniques. However, the size and power requirements of such a tag make it unsuitable for use for tracking pets. Furthermore, the relatively high power transmitter (that is, for a spread spectrum system) and paging-type receiver suggests that the system is intended for use at relatively large ranges.

A system for tagging domestic pets should preferably be able to cope with a relatively large concentration of tags in a relatively small geographical area. However the above-described asset tracking system uses maximal length (m-sequence) coding which is relatively poor at distinguishing between transmissions from different tags and which could also potentially suffer from the “near-far” problem (where the correlation with a strong signal having an incorrect code is greater than with a weaker, more distant signal with the correct code). A further problem with this system is the size, cost and power consumption of the paging-type receiver.

Generally a tag for a domestic pet needs to be simple, cheap, easy to use, and small and light so as not to encumber the animal. It should also combine a useful range with a useful battery life. Ideally the tag transmitter should provide a range of at least 100 m whilst the power consumption should be sufficiently low that a battery of a size that can comfortably be carried by the pet, which may be a cat, will last at least approximately one month. Hitherto these requirements have been seen as conflicting—for the required range a conventional transmitter operating at around 1 GHz would need an output power of ˜0.1 Watt which, assuming an optimistic 10% efficiency, will draw 1 Watt from a battery. A typical nickel cadmium AAA battery, about the maximum size which a cat could carry, has a capacity of ˜500 mAH at 1.5V and thus the tag would have a transmit life of less than an hour. The present applicant has, however, recognised that there is a way in which these seemingly impossibly conflicting requirements can be reconciled.

### SUMMARY OF THE INVENTION

According to a first aspect of the invention there is therefore provided a pet tag, the tag comprising: a housing configured for attaching the tag to a pet; an internal power supply contained within said housing; and a spread spectrum transmitter contained within said housing; wherein said spread spectrum transmitter has a transmit power substantially equal to or less than 1000 μW.

Preferably the spread spectrum transmitter has a transmit power substantially equal to or less than 500 μW, more preferably substantially equal to or less than 200 μW. Preferably the spread spectrum transmitter has a spreading code length equal to or greater than 2⁴−1 bits, more preferably equal to or greater than 2⁶−1, 2⁸−1 or 2¹⁰−1 bits.

By using a spread spectrum transmitter advantage can be taken of the processing gain available in a spread spectrum-based system, thus allowing an acceptable range to be achieved at very low transmit powers. Furthermore the main power drain on the battery results from the rf stages of the transmitter, and although a spread spectrum transmitter is more complex than a conventional transmitter much of the complexity is in digital logic circuitry, and the power consumption of this portion of the transmitter may be reduced to microamps with modern components. Greater processing gain and longer ranges even with reduced transmit powers can be achieved using longer spreading sequences, providing that the increased signal acquisition time at the receiver can be tolerated. Preferably a direct sequence spread spectrum transmitter is used as this simplifies the tag transmitter design.

The internal power supply may comprise a battery or a large-value capacitor and may be trickle charged by solar power. The housing may be configured for attachment to a pet by providing, for example, a loop though which a collar may be threaded.

The spread spectrum transmitter may be permanently connected to said internal power supply so that the transmitter is always on and transmitting, either continuously or in pulses, except when the battery has run flat or is being replaced. Alternatively the supply of power to the transmitter may be manually switched so that, for example, the tag transmitter can be switched on when the pet is let out and switched off when the pet returns, thus preserving the battery life. To further reduce the drain on the battery, in either of these embodiments the spread spectrum transmissions may be switched on and off in a on:off duty cycle of, for example 50:50 or 10:90.

The tag may either be used to locate a lost pet, by using a suitable receiver to track down the source of the transmissions, or the tag may be used to provide a warning to the pet owner when the tagged pet strays beyond a predetermined range from the receiver, as determined by, for example, received signal strength.

According to a another aspect of the invention there is provided a tag for locating an object, the tag comprising: an rf transmitter to transmit a coded signal; and an acoustic command receiver to receive an acoustic command; and wherein the coded signal is transmitted in response to reception of an acoustic command.

The rf transmitter could be a narrow band transmitter such as an FSK (Frequency Shift Keying) data transmitter but is preferably a spread spectrum transmitter. Using an acoustic command receiver simplifies the command receiver circuitry and enables the provision of a smaller, lower power consumption tag.

Use of acoustic rather than, for example, rf commands allows the tag to take advantage of the differing characteristics of acoustic as opposed to rf propagation. For example, acoustic commands can be received within a metal enclosure which would substantially attenuate an rf command. The processing gain provided by spread spectrum transmission means that the tag transmitter output is not so greatly affected by such problems. A further advantage of using an acoustic command transmitter is, paradoxically, its relatively limited range. The effect of this is that only a few tags near the command transmitter need be stimulated, reducing the potential problem associated with transmitted signals from different tags causing interference at the tag detector/receiver.

Preferably the rf transmitter is a direct sequence spread spectrum (DSSS) transmitter as such transmitters are simpler and cheaper to construct than frequency hopping devices.

In one embodiment the spreading sequence comprises a Gold code. These codes are described in more detail later. Such codes are relatively simple to implement whilst providing sufficient codes to reduce the risk of collision between transmissions from different tags, providing the number of tags excited by the command transmitter is not too great. Use of a Gold code allows improved code domain multiple access (CDMA) for distinguishing between tags.

There is a balance to be achieved between the number of different codes provided, the processing gain provided by a code and the command transmitter range. Advantageously the spreading sequence for the DSSS transmitter is less than or equal to 1023 chips (that is spreading code bits) and more preferably less than 255 chips. For an acoustic command receiver these values allow a reasonable compromise between acquisition time for the coded transmissions, number of codes and collision avoidance between transmitting tags.

Preferably the transmitter provides an ERP of 10 mW, more preferably ≦5 mW, and most preferably ≦2 mW. An ERP of 1 mW provides sufficient transmit range for a tag with an acoustic command receiver, where the effective range is dominated by the command transmission range.

In an alternative embodiment the spreading sequence comprises a Kasami code, which at the expense of slightly increased tag complexity and greater receiver complexity, provides many more CDMA codes. Thus a Kasami code is useful for tags detectable at greater ranges, and also when the acoustic command receiver is substituted by a longer range command receiver, such as an rf command receiver. The larger number of codes for the same sequence length provided by a Kasami code makes this code particularly advantageous when there is no modulation by baseband data, as described below.

In on embodiment the spread spectrum code is modulated by baseband data which includes a tag identity. Thus once the tag detector has locked onto the code the tag identifier can be read. The combination of the code and the tag identifier together serve to distinguish between a large number of different tags.

In a preferred embodiment the command receiver is responsive to acoustic commands which are substantially inaudible to most adult humans. Thus in one embodiment a tag is caused to transmit by means of a dog whistle. Such high frequency acoustic signals carry well and cause little disturbance to others, which is important when searching a neighbourhood for a lost pet. The command receive can be chosen to be responsive to a tone of a particular frequency or to a range of frequencies above a predetermined 3 dB cut-off frequency. Greater sensitivity and increased immunity to false triggers is achieved by using a narrow bandwidth tone detector, with a bandwidth of ≦1 KHz, more preferably ≦500 Hz and most preferably ≦100 Hz. The narrower the frequency band, however, the more precisely tuned must be the whistle or other command transmitter.

In another aspect the invention provides a tag for locating an object, the tag comprising: a command receiver to receive a command; and a spread spectrum rf transmitter, the spread spectrum transmitter having a spreading code; wherein the transmitter transmits a spread spectrum signal responsive to a received command; and wherein the transmitted signal conveys the spreading code unmodulated by baseband data.

By transmitting only the spreading code, both the tag and tag detector are simplified. Effectively the spreading code sequence itself is used for identifying the tag rather than any baseband data modulated onto the spread spectrum transmitted signal. The tag can be considered to be transmitting a single bit of baseband information, namely the presence or absence of the spreading code. With such a system it is possible to encode further information by, for example, altering a length of time of the code transmission, but it is preferable that the spreading code alone conveys the identity information of the tag, that is, only spreading code information is transmitted.

Either a Gold or a Kasami code can be used with such a tag, although Kasami codes are preferred as they provide a larger number of codes for a given sequence length and hence a greater number of different tag identifiers. Because the code is not modulated by baseband data, the chip rate of the spread spectrum transmitter can be increased without greatly adding to the cost or complexity of the tag. This allows longer spreading sequences to be used for the same detector/receiver acquisition time, which again increases the number of available codes.

Preferably the spreading sequence is less than ˜16K chips in length, more preferably, less than ˜4K chips in length. The improved CDMA access capabilities provided by the larger number of codes allows a system with increased range to be constructed for a given risk of collision between signals from tags with the same spreading code. Likewise the longer code provides greater processing gain and hence increased range. Thus such a system is suitable, for example, for locating animals which stray further afield such as larger dogs.

To achieve increased command transmitter range with such a system an rf command receiver is preferred. This can be a straightforward AM or FM receiver with tone detection circuitry or a more complex receiver for responding to a predetermined pulse sequence, or a simple tuned circuit for responding merely to the presence or absence or an rf carrier at the appropriate frequency. With this latter arrangement it is preferred that the receiver is sensitive to a carrier within a relatively narrow band, ≦1% and preferably ≦0.1% of the carrier frequency, to provide the necessary sensitivity and selectivity.

Either of the above described tags can be powered either by batteries or by solar power, or by a combination of the two. When powered by solar power it is clearly desirable to incorporate some form of energy storage within the tag, such as a rechargeable battery or a large capacitor.

The command receiver is preferably arranged to switch power to the transmitter so that in a quiescent state it is only the receiver which is drawing power. Since the power consumption of the command receiver can be reduced below 1 mA, even a button cell can provide many months of life. Preferably when a command is received the tag transmits for a predetermined interval before power to the transmitter is once again cut off.

The turn-on signal received by the command receiver can also be used for transmitting a special sequence before the spread spectrum code to enable the detector/receiver to lock onto the code more quickly; preferably the transmit oscillator is allowed to settle before such a sync sequence is transmitted.

A set of tags is also provided in which each tag has a different spreading sequence. Most generally, the spreading sequences can be of different lengths, but for simplicity of tag detector design it is preferred that a set of codes of a chosen length is employed. As described below, Gold and Kasami codes are generated by means of shift registers with EXOR feedback taps. For a given Gold or Kasami sequence a so called “preferred pair” of shift register tap sets is required and this preferred pair will generate one set of Gold or Kasami codes.

For a given length of shift register there is more than one preferred pair of tap sets, generally with different cross-correlation properties. Thus for a given spreading sequence code length, it may be desirable to use codes based upon more than one or upon all the preferred pairs available for that sequence length, so as to get maximum benefit from the number of different codes available. In practice, so called “balanced” codes (in which the number of 1's and 0's differs by one) are preferred as these do not generate a dc component in the output signal.

If space allows it is desirable to include a battery monitor within the tag since, generally speaking, the tag will only be commanded to transmit infrequently, making it difficult to keep a track of when batteries ought to be replaced. Alternatively, however, tag batteries can be replaced every few months as a matter of routine. The battery monitor preferably tests a battery under load since this gives a better indication of the battery's condition. Preferably the battery monitor should not itself draw excess power and may therefore comprise an indicator, such as an LED (Light Emitting Diode), with a short “on” duty cycle.

According to another aspect of the invention there is provided a detector for locating an object having a tag, the detector comprising: a direct sequence spread spectrum (DSSS) receiver for receiving from the tag a spread spectrum signal based on a Gold or Kasami code; a first aerial coupled to the receiver; input means for user selection of a said Gold or Kasami code; and indicating means for indicating when a tag with the selected code is detected.

The input means allows the user to select the spreading code of the tag to be located and the DSSS receiver will, generally speaking, then only lock onto signals from tags with this code. If a tag includes means for modulating baseband identity data onto the spread spectrum signal, this can also be entered into the detector. In such a system there are two parameters which should be matched to identify a tag—the spreading code and the identity data modulated onto it.

In a system where there is a limited number of codes, which is most likely where the is a short range acoustic command receiver, there is the possibility of locating a tag with the correct spreading code but the wrong identity. In this situation it is helpful to a user if separate indications of code lock and tag identity match are provided and/or some indication is provided of the receiver locking onto a tag with the correct spreading sequence but an incorrect identity code.

Where the detector is used with a tag having an acoustic command receiver, the acoustic command can be simply and cheaply provided by means of, for example, a dog whistle. In this case, for user confidence it is helpful if the detector indicates when an acoustic command is transmitted. In other embodiments the receiver includes means to issue an acoustic command signal to a tag, for example, by means of a piezoelectric transducer. Alternatively the detector may include an rf command transmitter.

During the interval in which the tag is expected to be transmitting the receiver advantageously provides an indicator, such as a flashing LED, showing that the receiver is searching for a transmitted signal which may be present. If desired the receiver can be arranged only to search for a code lock during this period.

The detector is preferably portable and hand-held and includes a directional aerial. This may be mounted directly on the detector or separately attachable to the detector. In a preferred embodiment the detector includes an approximately omnidirectional antenna and a directional antenna such as a Yagi, so that the omnidirectional antenna can be used to determine whether the tag is nearby and the directional antenna can be used to locate the approximate direction in which the tag is to be found.

According to a still further aspect of the present invention there is provided a system for alerting a user having a tag receiver to separation from a tagged object, the system comprising a tag and a tag receiver, the tag comprising: an activation/deactivation control device; and a transmitter coupled to the control device; the tag being configured to: upon activation, start transmitting; and upon deactivation, transmit a deactivation signal and cease transmitting; the tag receiver comprising: a receiver for receiving transmissions from the tag; a detector, coupled to the receiver, for detecting a reduction in the strength of signal received from the tag and for detecting reception of the deactivation signal from the tag; and an alarm device, coupled to the detector, for providing a user alert when a reduction in signal strength is detected without a deactivation signal.

The invention also provides a corresponding tag and tag receiver.

The tag is configured to transmit a deactivation signal before stopping transmitting, upon deactivation. The receiver is able to detect this deactivation signal and thus distinguish between intentional deactivation of the tag and the reduction in signal strength which occur when the receiver is gradually withdrawn from the tagged object when the object is accidentally left behind. In this way the receiver is able to differentiate between intentional and unintentional cessation of reception of signals from the tag.

In another aspect the invention may detect a rate of reduction of received signal strength and use this to differentiate between the tag being left behind and the tag being deactivated. Thus a gradual reduction in received signal strength indicates that the user of the system is withdrawing slowly from the tagged object whereas a sudden cessation of signal reception indicates that the tag has been deactivated.

Preferably the tag is configured to transmit a deactivation signal upon deactivation as this is more reliable, but a system which detects a sudden cessation of transmission to detect deactivation may be preferred for applications where the tag cost, size or power consumption are overriding factors since by omitting means to transmit a deactivation signal the tag may be smaller, cheaper, and lower in power consumption.

Means to transmit a deactivation signal may be incorporated within the tag transmitter or may form part of the activation/deactivation control device. In a simple embodiment the control device merely comprises a switch; in other embodiments the control device may be operated by a push button and provide a control output on a control line to the transmitter to control the transmitter to transmit the deactivation signal.

The detector in the tag receiver may detect a reduction in received signal strength to below an alert-triggering threshold or a reduction by a predetermined amount or factor. The detected reduction may comprise a partial or a complete signal loss. The alarm device may provide a direct user alert, such as a warning tone, flashing light, or silent vibration, or an indirect alert, such as a signal to a pager or mobile phone. Preferably, however, a direct alert is provided as this enables the user to take immediate action to prevent loss of the tagged object.

In one embodiment the deactivation signal comprises at least one pulse—that is, the transmitter output signal is pulsed or the signal transmitted from the tag is modulated with at least on pulse. The pulse may be of a predetermined duration; a plurality of pulses may be employed.

Whilst the above described system is adequate in many circumstances, it may be desirable to provide increased security, particularly where the tagged object is especially valuable. The tag effectively provides a beacon which could alert a miscreant to the valuable object's presence. Preferably, therefore, the tag is an rf tag providing an rf output modulated by a baseband signal comprising at least the deactivation signal, and wherein the half power bandwidth of the rf output is at least ten times the half power bandwidth of the baseband signal. Preferably the tag transmitter is a spread spectrum transmitter, such as a direct sequence or frequency hopping spread spectrum transmitter.

Use of a spread spectrum transmitter makes tag transmissions hard to detect unless the spreading code is known. The tag transmitter may approximate the Bluetooth (RTM) standard, which is advantageous as transmissions from the tag may then be hidden by other Bluetooth transmissions. In a simplified spread spectrum system the transmitter may be keyed on and off by a signal, such as a tone, with a narrow mark:space ratio. Such narrow AM pulses provide a broad transmit spectrum.

The control device may comprise an orientation-operated switch such as a mercury tilt switch or a tremble switch. This simplifies tag installation where a push button is undesirable. With this arrangement the user must always leave the tagged object in a predetermined orientation. For example, an umbrella normally lies horizontally but is carried vertically or at an angle. An external push button may also be avoided using a capacitatively operated switch or a magnetically operated switch such as a reed or Hall effect switch.

In yet another aspect the invention provides a system for alerting a user having a tag receiver to separation from a tagged object, the system comprising a tag and a tag receiver, the tag comprising: a spread spectrum transmitter, and a switch coupled to the spread spectrum transmitter for switching the spread spectrum transmitter on and off; the tag receiver comprising: a receiver for receiving transmissions from the tag, a detector, coupled to the receiver, for detecting a reduction in the strength of signal received from the tag, and an alarm device, coupled to the detector, for providing a user alert when a reduction in signal strength is detected.

In another aspect the invention provides a tag for use with a tag detector radar, the tag comprising: a pseudonoise (PN) code generator for generating a spreading code for a spread spectrum system; and a modulator and antenna combination for providing a modulated radar return from the tag; wherein the PN code generator is coupled to the modulator for modulating the radar return with the spreading code.

The pseudonoise (PN) code is used to modulate a radar return rather than to directly modulate a transmitted signal as in conventional spread spectrum transmitters. The same codes can, however, be used, and include m-sequence codes, Gold codes and Kasami codes. The usual spread spectrum code properties are desirably, namely a high autocorrelation coefficient and a low cross-correlation coefficient for the pseudorandom sequence.

The spread spectrum PN code can be modulated onto the radar return using either phase or amplitude modulation. For phase modulation the incident radar signal is mixed with the PN code using, for example, a Schottky diode, or other low-bias diode, or a dual gate FET. Amplitude modulation can be achieved using a switch, controlled by a PN code generator to either load the aerial or short out a dipole.

As in the tags described above, power to the PN code generator can be switched. In an alternative embodiment, however, the tag can be powered using the incident rf radar radiation. This is particularly advantageous in short-range systems.

Dispensing with the tag transmitter allows the tag to be smaller and cheaper and to have a reduced power consumption. This is particularly advantageous where the spreading sequence is long, thus requiring a relatively high chip frequency to allow a reasonable code acquisition time (in the applications envisaged, of the order of 1 second). Thus this arrangement is particularly useful when the spreading sequence is equal to or greater in length than 1023 chips and/or where the chip clock frequency is equal to or greater than 5 MHz, 10 MHz, or particularly 20 MHz.

According to a further aspect of the invention there is provided a radar detector for a tag providing a radar return modulated with a spread spectrum code, the detector comprising a radar front end coupled to a spread spectrum receiver.

Preferably the system includes a high pass filter to reduce the level of a dc component in the baseband signal due to unmodulated returns from the tag. In an AM system, the spread spectrum receiver can be simpler than conventional phase shift keying spread spectrum receivers as there is no need for carrier tracking (or, equivalently at dc, I and Q processing paths) so that correlation is achieved using a single code slip and track/lock loop.

The radar can use either a single aerial for transmission and reception or, for improved isolation, separate transmit and receive antennas. Preferably high gain, directional antennas are used to provide greater incident power, greater return signal sensitivity, and improved directionality for more accurate tag location and to reduce the volume interrogated, reducing the level of mutual interference between returns from different tags.

The invention also provides a method of detecting one of a plurality of tagged objects, the method comprising tagging the objects using a tag providing a modulated radar return from the tag; simultaneously illuminating the tagged objects with an interrogation signal using the above-described radar detector; and detecting one of said plurality of tagged objects using said detector. Preferably the method comprises detecting said tagged objects at relatively short range, particularly <10 m, more particularly <3 m. Preferably the tagged objects comprise files of documents.

### BRIEF DESCRIPTION OF THE DRAWINGS

These and other aspects of the invention will now be further described, by way of example only, with reference to the accompanying figures in which:

FIGS. 1a and 1b show, respectively, use of a spread spectrum tag and detector, according to an embodiment of the invention, to locate a cat, and a cross-section through a pet tag;

FIG. 2 shows the architecture of a spread spectrum tag;

FIG. 3 shows a command receiver for the tag of FIG. 2;

FIG. 4 shows a spread spectrum transmitter for the tag of FIG. 2;

FIGS. 5a-c show, respectively, a PN code generator, a time delay element, and an m-sequence shift register;

FIG. 6 shows a second PN code generator;

FIG. 7 shows hardware for generating a modulated spread spectrum transmission;

FIG. 8 shows hardware for generating a start-up synchronisation sequence;

FIG. 9 shows a battery monitor;

FIGS. 10a-c show, respectively, a physical layout, side, and top views of a tag;

FIGS. 11a and b show, respectively, a physical layout and a side view of a second embodiment of a tag;

FIGS. 12a and b show, respectively, first and second embodiments of a detector for the tag of FIG. 2;

FIG. 13 shows a block diagram of a tag detector according to an embodiment of the invention;

FIG. 14 shows an rf front end for the detector of FIG. 13;

FIGS. 15a and b show, respectively, first and second embodiments of a DSSS receiver for the detector of FIG. 13;

FIG. 16 shows use of a spread spectrum tag with a radar detector to locate a file;

FIGS. 17a-e show, respectively, a spread spectrum tag, a data modulator circuit element, first and second rf mixers and a tag power supply;

FIG. 18 shows a physical embodiment of the tag of FIG. 17;

FIGS. 19a and b show, respectively, a radar front end and a spread spectrum receiver for the tag of FIG. 17;

FIG. 20 shows a tagged object and a receiver for alerting a user to impending loss of the object;

FIGS. 21a and 21b show, respectively, a tag and a tag receiver;

FIGS. 22a and 22b show, respectively, a block diagram of a tag and of a spread spectrum transmitter; and

FIG. 23 shows a block diagram of a receiver for the tag of FIG. 22.

### DETAILED DESCRIPTION OF THE PREFERRED EMBODIMENTS

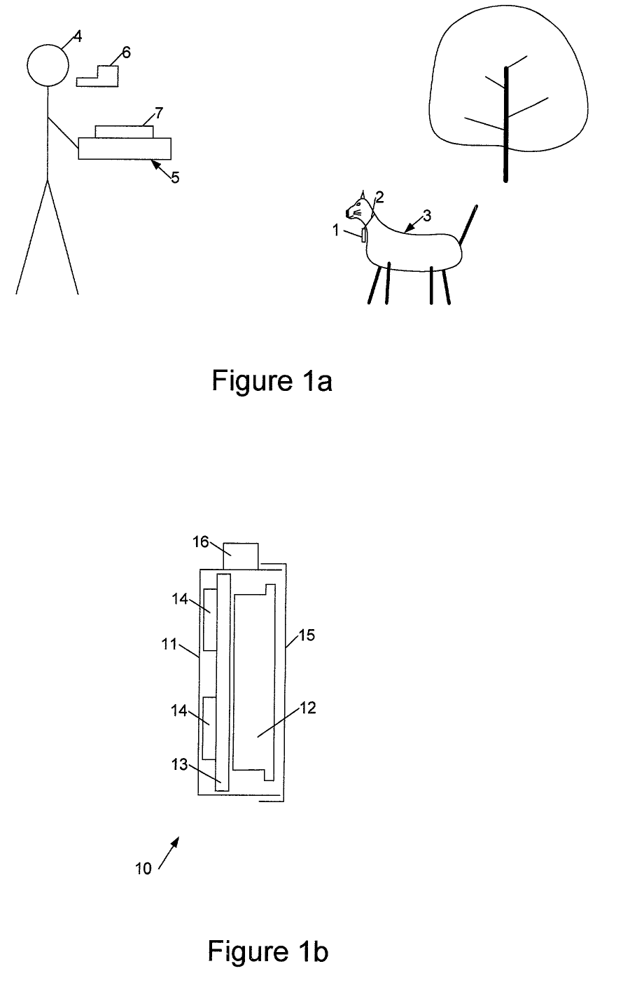

Referring to FIG. 1a, this shows a tag 1 fitted to a collar 2 of a lost cat 3. Its owner 4 is equipped with a tag detector 5 and a dog whistle 6. The owner blows on the dog whistle to start the tag transmitting for a predetermined interval, which may be in the range 10-30 seconds, but which can be longer, for example up to 2, 5, or 10 minutes. Whilst the tag is transmitting the owner uses an omnidirectional aerial (not shown in FIG. 1) on detector 5 to ascertain that the tagged cat 3 is in the vicinity, and then switches to directional aerial (not shown) covered by a plastic housing 7 to identify the direction from which the transmission originates. In this way the lost cat 3 can be tracked down and retrieved.

In one embodiment the tag is powered by a button cell and is generally disc-shaped, with the tag circuitry mounted behind the button cell. The button cell may be accessible for replacement via a clip or screw-fitting cover which optionally mounts one terminal of the battery connection. This embodiment is particularly preferred for a simple ‘always-on’ or manually-switched tag, which can be smaller then a tag responsive to a dog-whistle on-command.

Referring now to FIG. 1b, this shows a cross-section through an exemplary tag 10 which, because it may have a relatively small size, is suitable for a small pet such as a cat. The tag comprises a plastic or metal housing 11, which is preferably water-resistant, containing a button cell type battery 12 and a circuit board or substrate 13 mounting tag components 14. The housing has a removable cover 15 for replacing battery 12, and a formation 16 having an aperture (not shown) for attaching the tag to a pet's collar. An antenna (not shown in the cross-section of FIG. 1b) comprising, for example, a patch or a short flying lead is preferably also provided, although the circuitry may radiate sufficiently without a dedicated antenna. Where a flying lead is employed this may form one arm of a dipole, the other arm being provided by the button cell and/or circuitry.

Where the tag 10 of FIG. 1b is ‘always on’ power may be permanently applied to the tag circuitry whilst a battery is fitted and the cover is in place. Alternatively the power to the tag may be switched, for example manually. A switch may be provided, for example, by low-profile contacts on the inside of the housing 11 and on the cover 15, positioned such that rotation of the cover makes and breaks the contacts to switch transmissions from the tag on and off. Other alternative switching arrangements are described later and include capacitative switching. For example, the battery or a metal plate may comprise one terminal of a capacitor, the other terminal or plate being formed by a finger or hand near to or touching the housing or cover adjacent the battery or metal plate, the change in capacitance to ground being detected to toggle the tag on and off.

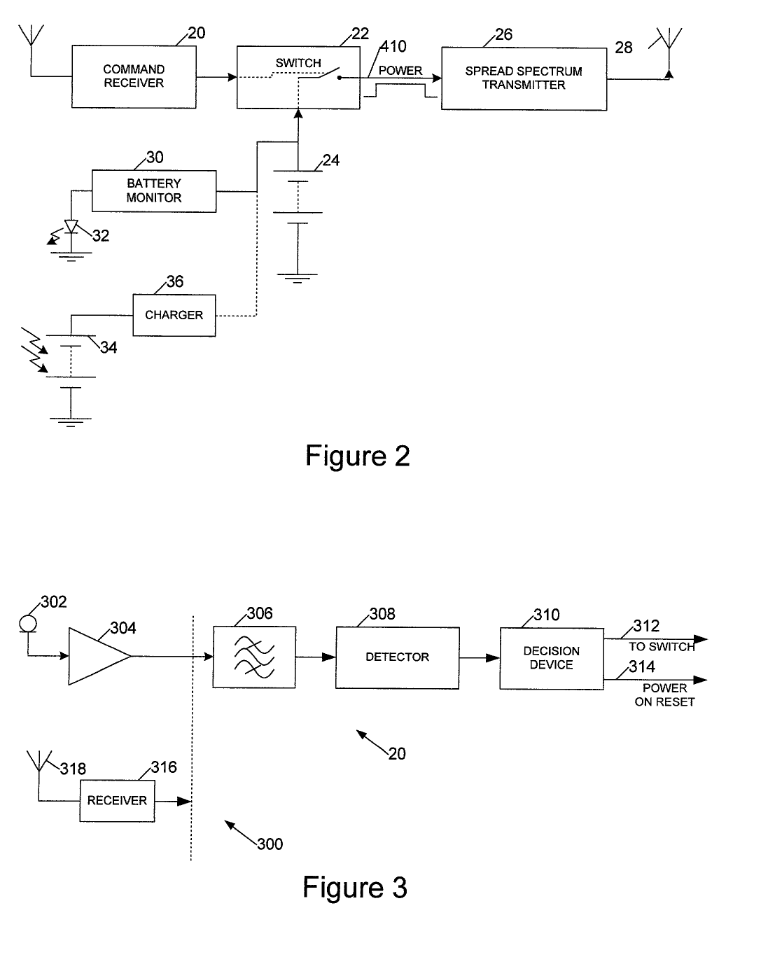

Referring now to FIG. 2, this shows the internal architecture of a switched spread spectrum tag. A command receiver 20 is responsive to the dog whistle to control switch 22 to apply power from battery 24 to spread spectrum transmitter 26, which then radiates on antenna 28. The transmit power depends upon the desired range and battery life but, as will be shown below, a power of 1 mW is sufficient for locating a lost cat.

Command receiver 20 draws power continuously from cell or cells 24 and thus must be configured for low current consumption. The principles of such design are well known to those skilled in the art. Use of even an AAA cell is undesirable for a cat tag because of its size and weight and button or similar type cells, for example silver oxide cells, offer a smaller and lighter option.

To lengthen the battery life of such a cell it is preferable that command receiver 20 is relatively simple and one way of achieving this is to use acoustic rather than rf commands. The command receiver and switch are preferably configured so that power is applied to the spread spectrum transmitter for a predetermined time interval, as indicated above, which helps to reduce the effects of false or unwanted triggers. As described above, an owner blowing the dog whistle would stimulate all tags within range to transmit and it is therefore beneficial if when triggered a tag transmits for a relatively limited period of time. In an alternative arrangement some selectivity may be provided by arranging for subsets of tags to respond to different command signals to reduce the likelihood that any one tag will be unnecessarily triggered. This can be achieved by using acoustic stimuli of different frequencies and/or pulse patterns.

In some embodiments command receiver 20 may be omitted and the tag either switched on and off manually or operated in an ‘always-on’ mode, transmitting at low power either continuously or in a continuous train of pulsed transmissions whilst a battery is installed within the tag. For such an arrangement to provide a practicable battery life the power consumption of the tag must be very low, preferably less than 1 mW and more preferably around 0.1 mW or less. Such low transmit powers would not normally provide a useful reception range for transmissions from the tag but with a spread spectrum system the processing gain, which is dependent upon the length of the spreading code sequence can be used to bring the range back up to an acceptable value.

In one embodiment the spread spectrum transmitter has a nominal output power of 0.1 mW which, for a 5% efficiency transmitter, will draw 0.67 mA from a 3 volt battery. A CR2032 button cell is approximately 20 mm in diameter and 3.2 mm in thickness and has a capacity of approximately 200 mAH so that a cell of this type will have a nominal life, for an ‘always-on’ tag transmitter, of approximately 12 days. Where the tag is manually switched on for an average of, say, 6 hours out of every 24 or pulsed with an on:off duty cycle of 1:3, this battery life is increased to approximately 48 days. Alternatively if a slightly larger button cell, such as the 540 mAH CR2450N (24.5 mm×5 mm) the unpulsed ‘always-on’ capacity is around a month (30 days).

A transmit output power of around 100 microwatts with a spreading code sequence length of 127 bits (‘chips’) is capable of providing a range, in urban conditions, of over 100 meters with a signal acquisition time of around 0.5 seconds for a 127 Kbps chip rate. Even a spreading code sequence length of 15 (or, equivalently, a transmit power of around 10 microwatts with a spreading code sequence length of 127 chips) provides a notional range of about 60 meters, with a signal acquisition time of under 10 milliseconds for a 127 Kbps chip rate. Some further, more detailed examples of system design are given later. It can therefore be seen that the twin objectives of both an acceptable transmit range and an acceptable battery lifetime can be achieved with such system design parameters.

Where the spread spectrum transmissions are pulsed it will be appreciated that the time for which the transmission is on should be at least as long as the signal acquisition time, and preferably at least twice this time, and some time should preferably also be allowed for the transmitter oscillator to settle. Thus shorter spreading sequences are preferred for pulsed transmissions and the transmit power may, if desired, be increased to partially compensate for the reduced processing gain available, because of the relatively large potential power savings from pulsing the transmitter. For example a 10:1 (off:on) duty cycle can increase battery life by a factor often and with a spreading code sequence length of 15 and a 10 ms signal acquisition time a 50:1 duty cycle will still provide two transmission pulses per second, acceptable for tag tracking or providing a tag-out-of-range warning and giving a factor of 50 increase in battery life. The transmitter 26 may be pulsed by substituting a pulse generator for command receiver 20 to control switch 22 in the arrangement of FIG. 2.

Referring again to FIG. 2, the tag preferably (where space allows) incorporates a battery monitor 30 which checks the condition of battery 24 at intervals and indicates by means of flashing LED 32 when power is low.

Optionally one or more solar cells 34 may be fitted to the tag to trickle charge a (rechargeable) battery 24 via charge 36. Alternatively, battery 24 may be eliminated and replaced by a large value (for example, 1 Farad) capacitor such as is used for memory “battery” back-up. The tag should have sufficient surface area exposed to light to generate enough power for the tag if the tag is to be entirely reliant on solar power, or where this condition is not met, solar power may be used to extend battery life.

FIG. 3a shows an acoustic command receiver 20 and FIG. 3b shows an alternative rf front end 300. In FIG. 3a microphone 302 is coupled to an input of preamplifier 304 and thence to bandpass filter 306 to broadly select the frequencies of interest. The output of filter 306 provides an input for detector 308 which is preferably a tone detector (for example, monostable-based) but which could also be a pulse detector. The output of detector 308 is coupled to decision device 310 (for example, a comparator) which provides outputs 312 and 314 to control switch 22 and to provide a power-on-reset signal respectively.

Alternative rf front end 300 demodulates a tone transmitted on an rf carrier, which is then processed in the same way as the audio input to filter 306. Since in general the frequency of the tone modulating the rf carrier will be known much more precisely than the frequency of the acoustic signal from the dog whistle detector 308 can be arranged to be sensitive to a very narrow band of tone frequencies, allowing much greater selectivity between received commands. Moreover, receiver 316 coupled to antenna 318 can be arranged to have a very narrow bandwidth, increasing sensitivity. Receiver 316 may be a conventional AM or FM receiver.

In the UK, frequency bands available for telemetry and telecontrol are at 433.05-434.79 MHz, 863.00-865.00 MHz, 868.00-870.00 MHz and 57 MHz (for radio control). There is also a planned band at 403-404 MHz. Most of these bands are limited to 10 mW ERP. There is no technical reason why the command transmissions should be made within these frequency bands and alternative, legally-available frequencies may also be used.

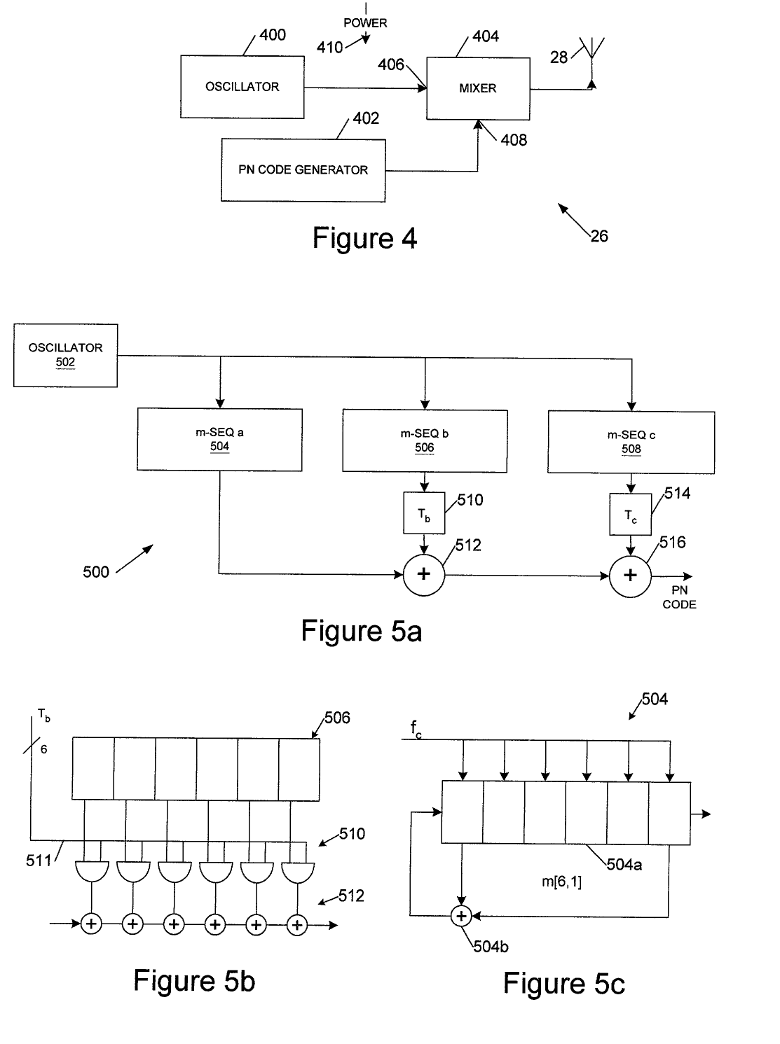

FIG. 4 shows a spread spectrum transmitter 26 for the tag of FIG. 2. An oscillator 400 generates an rf carrier which is provided to a first terminal 406 of mixer 404, the output of which is coupled to antenna 28. PN code generator 402 generates a spread spectrum spreading code which is applied to a second terminal 408 of mixer 404. Switched power is indicted schematically by arrow 410.

The output of PN code generator 402 is arranged to move between binary signal levels of +1 and −1 so that when mixed with the output of oscillator 400 a binary phase shift keyed (BPSK) signal is provided to antenna 28. Mixer 404 is preferably a balanced mixer and may be constructed from a dual-gate FET or from a differential amplifier. Other forms of modulation such as differential BPSK and CPSM (continuous phase shift modulation) can also be used.

Oscillator 400 is preferably physically small and has a relatively low current consumption and power output. In general oscillator 400 may operate at any frequency, although the frequency should be high enough to allow modulation of the PN code sequence onto the carrier without excessive spectrum occupancy. In the UK the ISM (Industrial, Scientific and Medical) frequency band of 2.4-2.4835 GHz is explicitly designated for spread spectrum transmissions provided these have an ERP of less than 10 mW per 1 MHz of spectrum occupancy. In the US additional frequency bands of 903-928 MHz and 5.725-5.85 GHz are also available for spread spectrum devices.

In the described embodiment oscillator 400 operates at about 2.4 GHz and provides an output power in the range 1 dBm to 10 dBm. A small, low-power oscillator for these frequencies can be constructed using a ceramic resonator or a stub comprising a resonant length of solid coax. Mixer 404 preferably incorporates a buffer and impedance matching circuitry to optimise its coupling to antenna 28. Mixer 404 may comprise, for example, a dual-gate FET or an integrated circuit such as the 3 volt RF2909 spread spectrum transmitter IC, or other ICs in this range, available from RF Micro Devices Inc. in Greensboro, N.C., USA.

Since a 1 dBm transmitter output is sufficient to provide the necessary range for a cat locating tag, no amplification is necessary for this application. Where longer ranges are required, for example for tags for medium to large dogs, a monolithic microwave integrated circuit (MMIC) can be employed to boost the transmitted output to around 10 dBm.

In alternative embodiments a spread spectrum transmitter may be constructed using the American Microsystems, Inc. SX043 integrated circuit, for example along the lines indicated in the “low cost spread spectrum FM radio transmitter” application note available on the AMI web site and hereby incorporated by reference. The PN code generator 402 generates a pseudonoise spreading code as is know to those skilled in the art for spread spectrum use. Such codes are described in Spread Spectrum Communications Handbook by M. K. Simon, J. K. Omura, R. A. Scholtz and B. K. Levitt, McGraw Hill, 1994 and in Digital Communication with Fibre Optics and Satellite Application by H. B. Killen, Prentice Hall International, Inc., 1988. Since the tags operate according to a CDMA arrangement for distinguishing between signals simultaneously transmitted from multiple tags within range of a command transmission, the PN code is preferably adapted for such a CDMA system. Particularly suitable are Gold codes, as described in “Optimal binary sequences for spread spectrum multiplexing” by R. Gold, IEEE transactions on Information Theory, Vol.IT13, p.119-121, October 1967, which is hereby incorporated by reference, and Kasami codes, described in “Cross-correlation properties of pseudorandom and related sequences” by D. V. Sarwate and M. B. Pursley, Proc. IEEE, Vol.68(5), p.593-619, May 1980, which is hereby incorporated by reference. Reference may also be made to the following, which are also incorporated by reference: CDMA—Principles of Spread Spectrum Communication by A. J. Viterbi, Addison-Wesley, 1995 and Digital Communications by J. G. Proakis, McGraw Hill International, 3/e 1995.

As is known to those skilled in the art, a PN code is a pseudorandom bit sequence with a strong autocorrelation at zero relative shift and a weak autocorrelation value elsewhere. Different PN sequences preferably have a low cross-correlation coefficient for both full and partial overlap. The bits of a PN spreading code are often referred to as chips. With a chip clock of f_{c} and a spreading sequence of length N_{c} a PN code has a line spectrum with a line spacing of f_{c}N_{c} and a sinc² envelope with nulls at ±f_{c}.

A PN code may be generated by an n-stage shift register with EXOR (modulo-2 addition) feedback taps at specified positions. A simple PN code is a maximal length sequence or m-sequence, which has a length of N_{c}=2ⁿ−1. Some exemplary shift register tap points are as follows:

| No of | Code | |
|---|---|---|
| stages | length | |
| (n) | (Nc) | m-sequence tap points |
| 6 | 63 | [6,1] [6,5,2,1] [6,5,3,2] |
| 7 | 127 | [7,1] [7,3] [7,3,2,1] [7,4,3,2] [7,6,4,2] [7,6,3,1] |
| | | [7,6,5,2] [7,6,5,4,2,1] [7,5,4,3,2,1] |
| 8 | 255 | [8,4,3,2] [8,6,5,3] [8,6,5,2] [8,5,3,1] [8,6,5,1] |
| | | [8,7,6,1] [8,7,6,5,2,1] [8,6,4,3,2,1] |
| 10 | 1023 | [10,3] [10,8,3,2] [10,4,3,1] [10,8,5,1] [10,8,5,4] |
| | | [10,9,4,1] [10,8,4,3] [10,5,3,2] [10,5,2,1] [10,9,4,2] |

The taps can be reversed, that is a tap at a position i is substituted by a tap at a position (n-i), for additional sequences. Further tap points are given in Table 12 of the SX041, SX042, SX043 Users' Manual published by American Microsystems, Inc. of Idaho, USA which specific table is hereby incorporated by reference.

Gold codes are produced by modulo-2 addition of a “preferred pair” of two m-sequences generated by two shift registers with the same number, n, of stages. A Gold code has a length of 2ⁿ−1 and a single preferred pair can be used to generate a set or family of 2ⁿ−1 different Gold code sequences (plus the two basis m-sequences). Each Gold code of a family is produced by combining the m-sequences with a different relative time shift; since there are 2ⁿ−1 possible time shifts there are 2ⁿ−1 different Gold codes in a set. The large number of different Gold codes available makes them useful in CDMA systems, although their autocorrelation functions are inferior to m-sequences. Gold code preferred pairs are listed in the paper by R. Gold mentioned above and in Tables 14 and 15 of the SX041, SX042, SX043 Users' Manual published by American Microsystems, Inc. of Idaho, USA. The specific Gold code preferred pairs listed are hereby incorporated by reference.

To avoid a dc component in the spread signal (which in the transmitted signal appears as a carrier spike) the codes are preferable “balanced”, that is the number of 1's differs from the number of 0's by one. Balanced codes are obtained when an initial 1 of one of the m-sequences corresponds to an initial 0 in the other m-sequence.

The generation of Kasami sequences is described in the paper and other references mentioned above. A Kasami sequence is based upon a Gold code, with the modulo-2 addition of a further third m-sequence. The third m-sequence is obtained by decimation of one of the other two m-sequences, that is by taking every qth bit of the sequence and repeating the decimated q times. It can be shown that such a decimated sequence is itself an m-sequence of order n/2. Such codes are known as Kasami codes from the large set; a small set of Kasami codes is generated by combining a single m-sequence with its decimated version. An advantage of Kasami codes over Gold codes is the increased number of codes available for a CDMA system, the number of codes being 2^{n/2}(2ⁿ+1). Clearly n must be even. As with Gold codes, balanced Kasami codes are preferred and, if a subset of these is to be selected, it is preferable to choose those with the lowest full or partial cross-correlation.

The sets of Kasami codes listed in the above references are hereby specifically incorporated by reference into this specification. Further codes, also incorporated by reference, are listed in the PhD thesis of J. P. F. Glas in the library of Delft University of Technology, Delft, The Netherlands, and reference can also be made to “Selection of Gold and Kasami code sets for spread spectrum CDMA systems of limited numbers of users” by S. E. El-Khamy and A. S. Balamesh, International Journal of Satellite Communications, p.23-32, No.5, 1987.

FIG. 5a shows a Kasami PN code generator 500. The generator comprises an oscillator 502 producing an output at the chip clock rate fc to m-sequence generators 504, 506 and 508 generating m-sequences a, b and c. Generator 508 produces a decimated version (c) of the sequence (a) from generator 504. The outputs of generators 506 and 508 are delayed by time delay elements 510 and 514 respectively, to allow a relative shift of the three m-sequences to generate a set of Kasami codes. The Kasami code generated depends upon the delays, in m-sequence bit or chip periods, introduced by these elements; it is assumed that the three m-sequence generators have a predetermined relationship between their sequences on start-up, for example all starting up in the all 1's state. The output from generator 504 and the delayed outputs from generators 506 and 508 are summed using EXOR elements 512 and 516 to produce the PN Kasami code. A Gold code may be generated by omitting sequence generator 508, delay element 514 and EXOR element 516.

FIG. 5b shows how a programmable delay may be implemented using a set of AND gates 510 each with one input from a stage of a shift register of m-sequence generator 506 and a second input from a line or bus 511 on which a required delay is selected. The outputs of the AND gates are summed in EXOR gates 512. FIG. 5c shows an implementation of m-sequence generator 504 comprising a 6-stage shift register 504a with taps at the 1 and 6 positions combined in EXOR gate 504b and fed back the shift register's input. This generates a 63-bit m-sequence code.

A set of Kasami codes for n=6 may be generated using a (Gold code) preferred pair of shift register tap positions for m-sequence generators 504 and 506. For example, where generator 504 has taps at positions [6,1] and generator 506 has taps at positions [6,5,2,1], m-sequence generator 508 has a length n=3 and taps at positions [3,2].

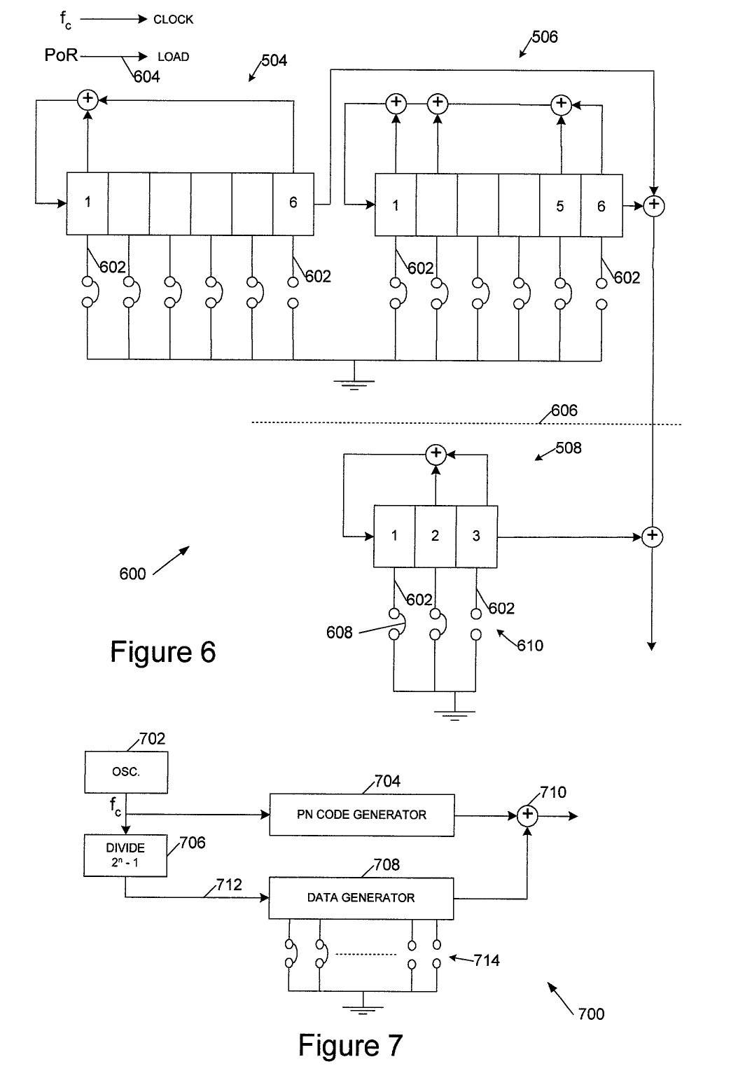

FIG. 6 shows a second implementation of a Kasami PN code generator 600, with taps at these positions. The three m-sequence generators are, for consistency, denoted by the same reference numerals as in FIG. 5a. In this embodiment the relative shift between the three m-sequence generators is achieved by loading the shift registers with a delayed version of the m-sequence at start-up. Effectively, each generator 504, 506, 508 starts at a predetermined point in its sequence and two of the generators are arranged to provide the desired relative time delay to the third sequence. Thus in FIG. 6, power-on-reset signal 604 is coupled to a load input (not shown) on each of the shift registers comprising code generators 504, 506 and 508. The data loaded into each shift register is determined by data input lines 602 which can be tied to ground or left open circuit (the lines have pull-ups which are not shown) to program the relative delay. If one of the generators starts at a predetermined point in its m-sequence, such as all 1's, a delay need only be programmed into the other two m-sequences (one of which is the decimated sequence).

The arrangement of FIG. 6 can also be used to generate Gold codes by omitting the circuitry to the right of dashed line 606 or by setting PN generator 508 to all 0's. Kasami codes from the small set can be selected by omitting PN code generator 506 (or by setting its output to a continuous 0). The m-sequence of each individual generator can be obtained by setting the outputs of the other two generators to 0 or omitting these generators.

In one embodiment for n=6 a Gold code preferred pair comprises m[6,1] for sequence (a) and m[6,5,2,1] for sequence (b). If a Kasami code is being used the third sequence generator 508 generates m[3,2] (n=3) for sequence (c).

The arrangement of FIG. 6 simplifies manufacture as tags can be produced with a set of links 608 selected ones of which are broken, as shown at 610, to program a code for the tag.

In one embodiment oscillator 502 is a stable oscillator such as a crystal oscillator. This assists a spread spectrum receiver in the detector in keeping track of the PN code.

FIG. 7 shows a spread spectrum transmitter in which a tag identity code is modulated onto the spreading code. Oscillator 702 generates an output at the chip frequency f_{c} for PN code generator 704. Code generator 704 preferably generates a Gold or Kasami code, but where the spreading code itself is not or is not on its own used for tag identification, the number of different CDMA codes available need only be sufficient to distinguish between signals from different tags stimulated to emit at the same time, and thus in one embodiment the code generator 704 generates a Gold code.

Data generator 708 has a clock input 712 derived from oscillator 702 by frequency division using divider 706. Driving the code generator 704 and data generator 708 from a single oscillator locks the two together and simplifies receiver design. The output of data generator 708 changes every code epoch and is combined with the output of PN code generator 704 by mixer (multiplier) 710. The code output by data generator 708 can be set by programmable or breakable links 714 in a similar manner to the PN code generator of FIG. 6. Alternatively, the arrangement of FIG. 7 can be implemented in software on a microprocessor, such as a microcontroller in the PIC 12C5XX series available from Microchip Technology, Inc.

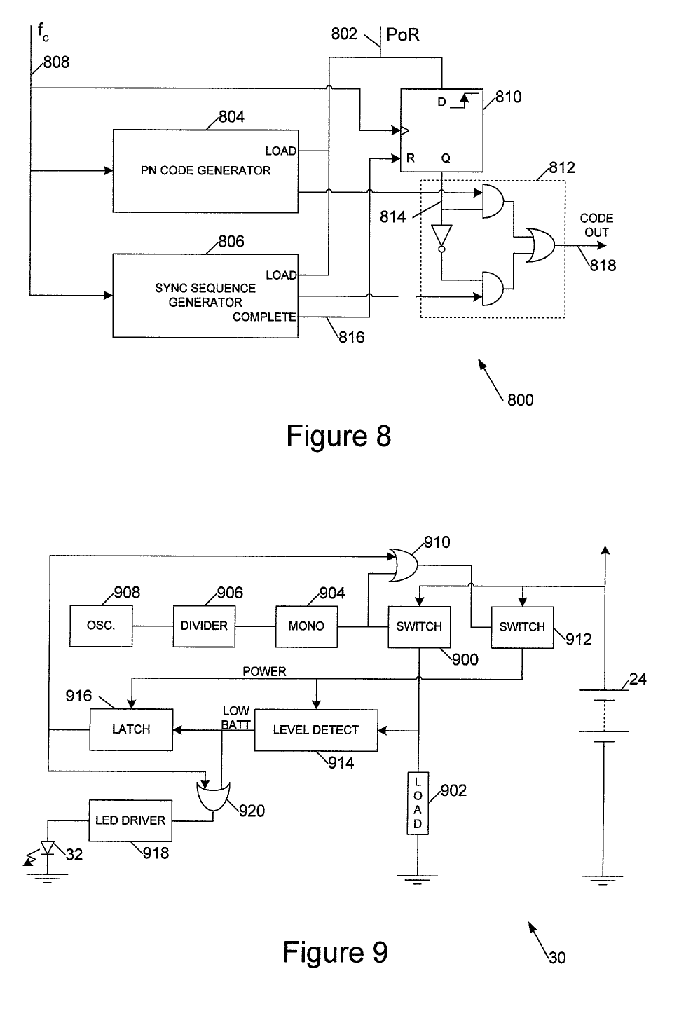

FIG. 8 shows a spread spectrum code generator 800 which provides a predetermined bit sequence on start-up. Such a synchronising bit sequence can be used in conjunction with a matched filter at a spread spectrum receiver to reduce code acquisition time since the synchronising code allows the spreading code sequence in the receiver to be approximately locked to the transmitter so the only small relative adjustments of the two codes are necessary to achieve full lock.

Power on reset signal 802 is used to preset both the PN code generator 804 and sync sequence generator 806 in a predetermined phase relationship. The power-on-reset signal 802 provides a rising edge (or a positive-going pulse, preferably shorter than the sync sequence duration) after a time interval from power being applied to the chip oscillator (not shown). This time interval allows the oscillator to settle before the receiver is synchronised.

As shown a signal 808 at the chip frequency f_{c} is applied to both the PN code generator 804 and the sync sequence generator 806. The output of one or other of these is selected by logic 812 in accordance with the output 814 of flip-flop 810. Power on reset signal 802 is applied to the D input of the flip-flop and sync sequence complete signal 816 resets the flip-flop so that code out signal 818 comprises first the sync sequence and then the PN code. Flip-flop 810 is clocked by chip clock 808 so that the selection of the PN code or sync sequence is synchronous with this clock. As shown, power on reset signal 802 should be high for a period longer than the sync sequence duration.

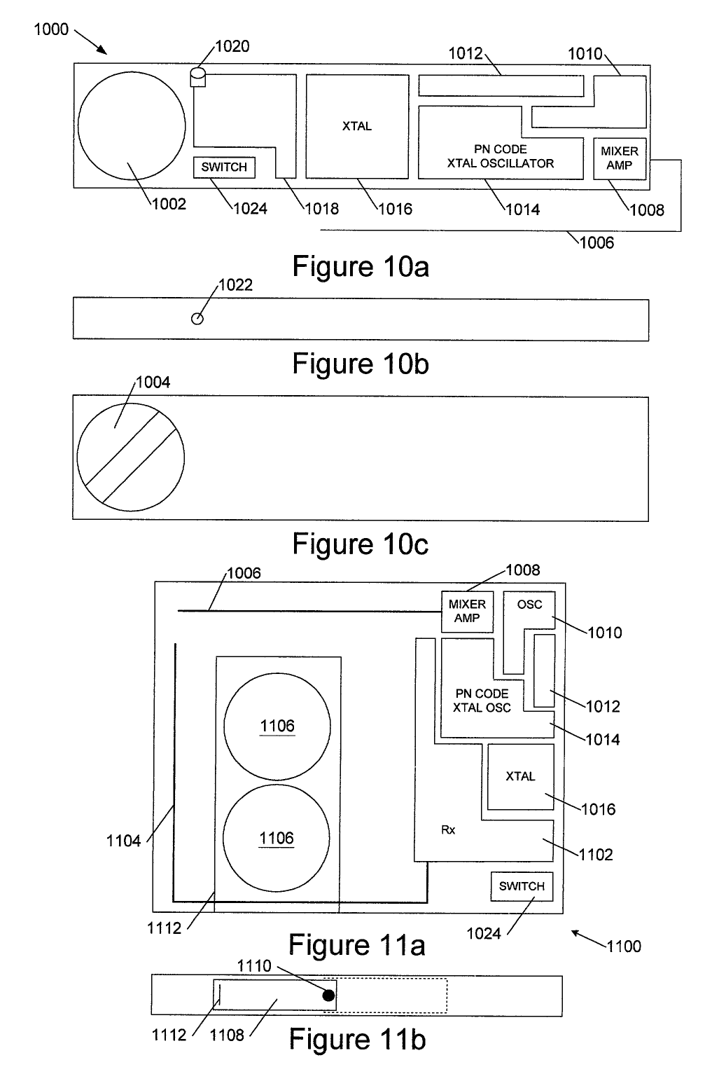

FIG. 9 shows a battery monitor 30 for use with the tag 10. A switch 900 is used to place a load 902 across battery 24, at intervals determined by oscillator 908 and divider 906, for a period determined by monostable 904. Whilst the load is applied OR gate 910 controls switch 912 to apply power to level detect circuit 914, latch 916 and LED driver 918. If level detector 914 detects that the battery output is low, latch 916 and OR gate 910 operate to maintain power to LED driver 918. The low battery level detect signal is input to LED driver 918 through OR gate 920 which operates with latch 916 to maintain the input when a low battery level has been detected. The LED driver drives LED indicator 32 to flash the LED with a short on-long off duty cycle, such as 10%:90% on:off, to conserve power.

FIG. 10 shows an example of a physical layout of components of a tag 1000 which is suitable for mounting on a cat's collar. The device is powered by a single button cell 1002, accessible via an opening closed by screw fitting 1004. The tag transmitter is coupled to a quarter wave antenna 1006 which can be fitted into the cat's collar; this forms one arm of an approximate dipole, the other arm of which comprises the tag components. The mixer/amplifier/matching circuitry is shown at 1008; if based on a dual-gate FET this may be relatively small. Oscillator 1010 is coupled to a ceramic or coaxial stub resonator 1012 to generate a 2.4 GHz output.

Crystal oscillator and PN code circuitry 1014 may either comprise dedicated hardware or a microcontroller such as the 8-bit CMOS PIC 12C508-04 8-pin SOIC (small outline IC) microcontroller from Microchip Technology Inc. Dedicated hardware may comprise surface mount or naked die components or a programmable gate array or an application specific IC (ASIC). The code generator is preferably driven by a crystal oscillator comprising crystal 1016. However, because the crystal is a relatively large component, it may be replaced by some other type of oscillator such as an RC oscillator, to save space, at the expense of a small reduction in tag detector sensitivity.

Audio circuitry 1018 is coupled to miniature microphone 1020 which is provided with an aperture 1022 on the exterior of the tag. Switch 1024 switches battery power to the code generator and oscillator/mixer.

At 2.4 GHz a quarter wave is approximately 3 cm, which allows the construction of a tag having a length of 4-5 cm, a width of approximately 1 cm and a height of roughly ½ cm (the width and height depend upon the size of button cell used). Conventional rf construction techniques may be employed; if miniaturisation is more important than cost the rf circuitry can be miniaturised by fabrication on silicon, which is offered as a service by American Microsystems, Inc. The tag housing may comprise metal, plastic or ceramic material, although for reasons of cost encapsulation in plastic, epoxy resin or similar is preferred. In a tag for a small dog the button cell can be replaced by an AAA size battery, or, for a larger dog by one or more AA batteries. Tags for larger animals also provide more space for, for example, an rf rather than audio command receiver.

FIG. 11 shows, schematically, a physical layout for a tag 1100 suitable for tagging files, and at FIG. 11b a side view of this tag. In FIG. 11 like features to FIG. 10 are denoted by like reference numerals. However, the tag has an rf command receiver 1102 coupled to aerial 1104. Likewise, the tag may operate at a higher frequency than the pet tag of FIG. 10, with a correspondingly reduced length of resonator 1012 and aerial 1006. The tag 1100 is approximately rectangular and is designed to attach to the from of a file of papers, and hence a wide, flat profile is preferred for batteries 1106. These batteries may be accessed via a window 1108 having a sliding closure 1110 and a tape 1112 to assist removal of the batteries.

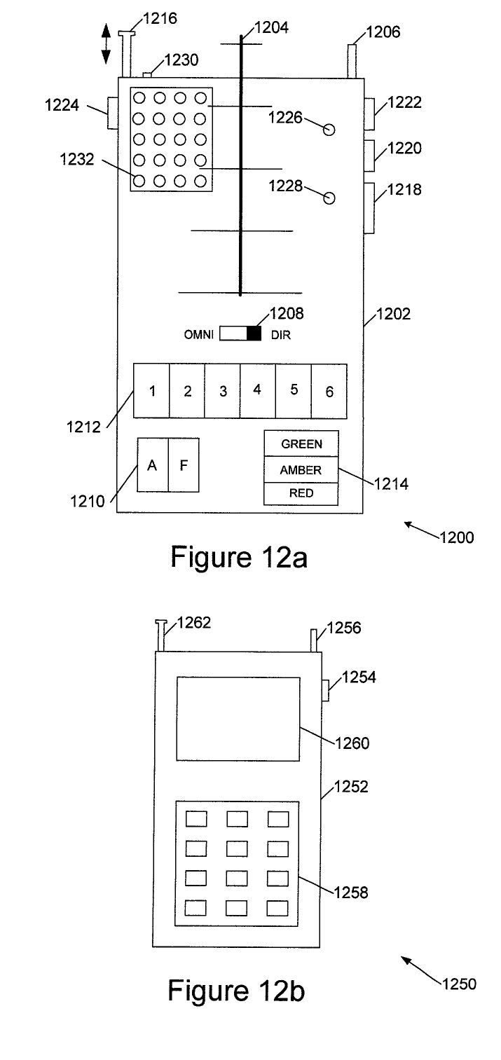

FIG. 12 shows two alternative embodiments of a detector 1200, 1250 for the tag of FIG. 2. The detector comprises a housing 1202, 1252 on which is mounted a directional Yagi aerial 1204. In the embodiment of FIG. 12b the Yagi is hand held separately from the detector and plugs into a socket 1254. The detector also has a substantially omnidirectional aerial 1206,1256; the aerial in use is selected by switch 1208 or keyboard 1258 in the alternative embodiment.

The spreading code sequence is selected by thumbwheel switches 1210 and the encoded tag identity by a second set of thumbwheel switches 1212 (or, in the alternative embodiment, by keyboard 1258). Where a tag is identified solely by its spreading code switches 1212 may be omitted whilst switches 1210 may need to be augmented. Generally speaking, the functions provided by switches on the embodiment of FIG. 12a are provided by keyboard 1258 in the alternative embodiment of FIG. 12b. Likewise the display 1260 of FIG. 12b serves in place of indicators described below on the embodiment of FIG. 12a. Both detectors may be provided with an extendible rf aerial 1216, 1262 where they are being used with tags with rf command receivers. The embodiment of FIG. 12a is designed to lie flat in the palm of a hand with Yagi aerial 1204 on top; the embodiment of FIG. 12b is similar to a mobile phone.

Referring to FIG. 12a, an on-off switch is provided at 1218, a command transmit button, where appropriate, at 1220, and a receiver lock reset button at 1222. Command transmit button 1220 may transmit an rf or an acoustic command, for example using a piezoelectric transducer. The detector is also provided with a detector test button 1224.

A received signal strength indicator is provided at 1214, a command transmit indicator at 1226 and a search/found indicator at 1228. In the case of an acoustic command transmission the command transmit indicator relies upon detecting an input at microphone 1230. An audible sounder 1232 (present but not shown in FIG. 12b) supplements the visual search/found indicator 1228.

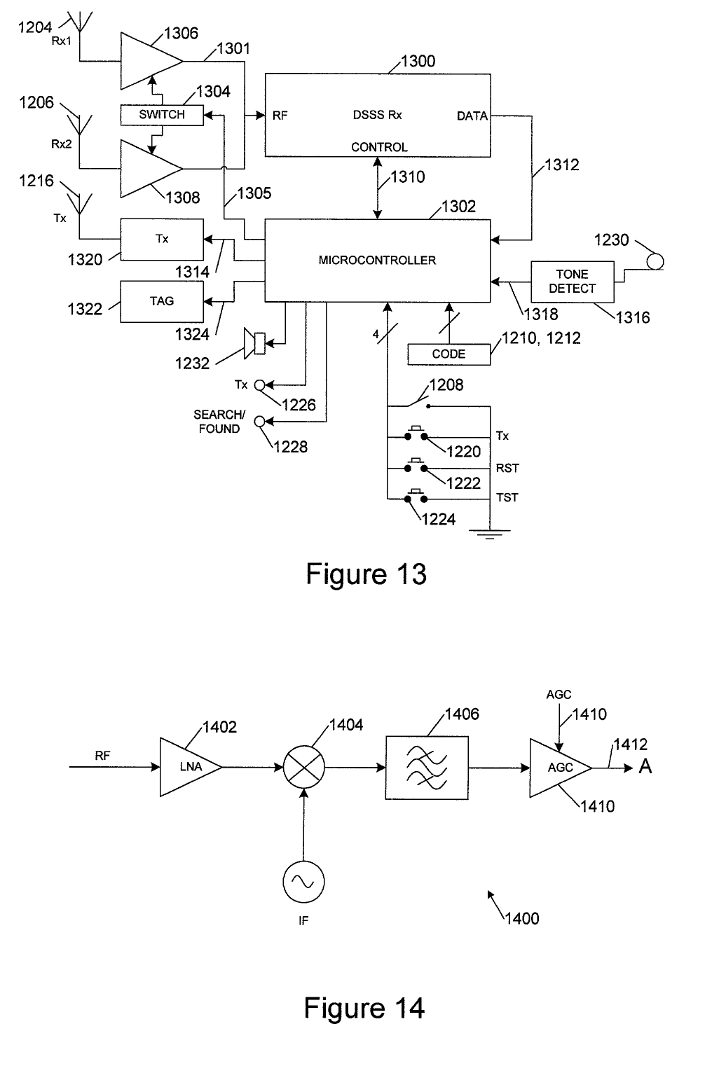

FIG. 13 shows a block diagram for the tag detector of FIG. 12a. The tag detector comprises a direct sequence spread spectrum (DSSS) receiver 1300 which receives an rf input 1301 selectable from antenna 1204 and 1206 by switch 1304 which operates to select one or other of preamplifiers 1306 and 1308, advantageously GaAs FET-based preamplifiers to provide a low receiver noise figure. The detector is controlled by microcontroller 1302 which interfaces to DSSS receiver 1300 via control lines 1310. The microcontroller also provides a control line 1305 to switch 1304 to select which antenna receiver 1300 receives input from; the microcontroller receives an input from switch 1208 for antenna selection. Microcontroller 1302 also receives demodulated baseband data from data output 1312 of receiver 1300. A spread spectrum code acquisition/lock signal is also available to microcontroller 1302 on control lines 1310. Microcontroller 1302 may be any general purpose microcontroller such as a microcontroller in the 8051 family.

The microcontroller receives inputs from code switches 1210 and 1212 and transmit 1220, reset 1222 and test 1224 buttons. The code selection input includes information identifying a spreading code for the tag to be detected. In the case of a pet tag, a pet's owner will know this code as it will be provided with the tag when the tag is purchased. If lost, it may be determined electronically by, for example, using a tag detector to manually or automatically step through all possible codes. Similarly the tag identity data is also provided with the tag on purchase or, alternatively, this may be programmed into a tag after purchase by a user by, for example, making or breaking links within the tag as described above. Again, if this identity information is lost it may be read from the tag once the spreading code is known.

Where the tag does not include baseband (identity) data, for example, where tag identity is based purely on the tag's spreading code, data output 1312 from receiver 1300 is not required. In this case tag detection is ascertained on the basis of control information on lines 1310 indicating that a lock to a signal bearing the required spreading code has been achieved. The spreading code entered on switches 1210 is programmed into the receiver 1300 by the microcontroller via control lines 1310, typically into data registers in the receiver.

The microcontroller receives an input on line 1318 from a tone detector 1316 coupled to microphone 1230; the detector may be similar to the arrangement shown on FIG. 3 for the tag. This allows the tag detector to determine when an acoustic command is issued to a tag and, when this command is inaudible, the microcontroller controls indicator 1226 and/or sounder 1232 to indicate the a command is issued. Since normally a tag will only transmit for a predetermined time interval after receipt of a transmit command, at this point the microcontroller may, if necessary, reset spread spectrum receiver 1300 and cause search search/found indicator to flash, for example, yellow, to indicate a search mode during which time a tag transmission could be detected. If a tag transmission is detected the microcontroller causes indicator 1228 to indicate a tag has been found by, for example, displaying a green light and, in addition, sounder 1232 may also be caused to emit a tone.

In a detector for tags with rf command receivers, tone detector 1316 and microphone 1230 may be omitted. In this case, however, it is useful to incorporate command transmission means within the detector. The means may comprise transmit button 1220 which, when operated, causes command transmitter 1320 to transmit a command via aerial 1216. Button 1220 causes microcontroller 1302 to control transmission by means of transmitter control line 1314. Alternatively transmit button 1220 can control an acoustic sounder to issue an acoustic command to an acoustically commanded tag. To reduce current consumption the acoustic sounder may transmit intermittently or emit pulses of sound. The pulses may be spaced to ensure substantially continuous transmission from a tag within range or they may be spaced, for example, every few seconds, to ensure a good chance of triggering a tag in a searched region to transmit as the detector is moved through the searched region.

It is desirable to provide a reset function for the tag detector to reset the spread spectrum receiver 1300 and/or microcontroller 1302, to reset processors in these devices and/or to reset the receiver's spreading code search/acquisition process. It is also desirable to incorporate a test function within the detector, operated by test button 1224. In one embodiment this causes microcontroller 1302 to issue a command over line 1324 to an in-built tag 1322 to begin spread spectrum transmission. This tag may need to be shielded within the detector to avoid swamping the receiver/preamplifier input circuitry. When the test is invoked the spreading code for the test tag is programmed into receiver 1300 by microcontroller 1302 to allow the receiver to detect the tag and the search/found indicator 1228 then operates in the usual way. This allows a simple test of the entire detector circuitry. After the test microcontroller 1302 reprograms the receivers registers with the spreading code of the tag to be located. Other means for testing the detector will no doubt occur to the skilled person. Both the “reset” and “test” functions bolster user confidence in the system.

In use the detector is switched on and the spreading code and, if necessary, the tag identity code, for the tag to be located are entered by means of switches 1210 and 1212. Switch 1208 is operated to select the omnidirectional aerial and a command is issued to the tag to be located to transmit, either by blowing dog whistle 6 or by pressing transmit button 1220 on the tag detector. Transmit indicator 1226 then illuminates and search indicator 1228 flashes indicating that the system is searching for a spread spectrum transmission having the appropriate code. If no transmission is identified, indicator 1228 is extinguished. If a code lock is achieved and the correct tag identity is read indicator 1228 shows a steady green light and sounder 1232 indicates that the transmission from the desired tag has been detected. If a transmission with the correct spreading code but incorrect identity data has been received this does not necessarily indicate that the desired tag has not been found since there could be an error in the received data and/or interference from another tag having the same spreading code hence the detector displays a flashing green light using indicator 1228 and an intermittent tone on sounder 1232. Once a code lock has been achieved signal strength indicator 1214 gives an approximate indication of the received signal strength using, for example, red, amber and green indicators to indicate low, medium and high received signal strengths.

Once a code lock has been achieve the user changes from omnidirectional antenna 1206 to directional antenna 1204 and rotates the detector or, if separate, antenna, to locate the direction the transmission is coming from. The combination of transmission and signal strength can then be used to home in on the tag transmitting the signal and to distinguish between two tags transmitting from different places using the same spreading code. The user can also confirm whether or not the tag identity matches that required. Although microwave rf transmissions can sometimes give a misleading indication of the direction from which they originate, because of reflections from buildings and diffraction around obstacles, with time it is nevertheless possible to locate a transmitting tag.

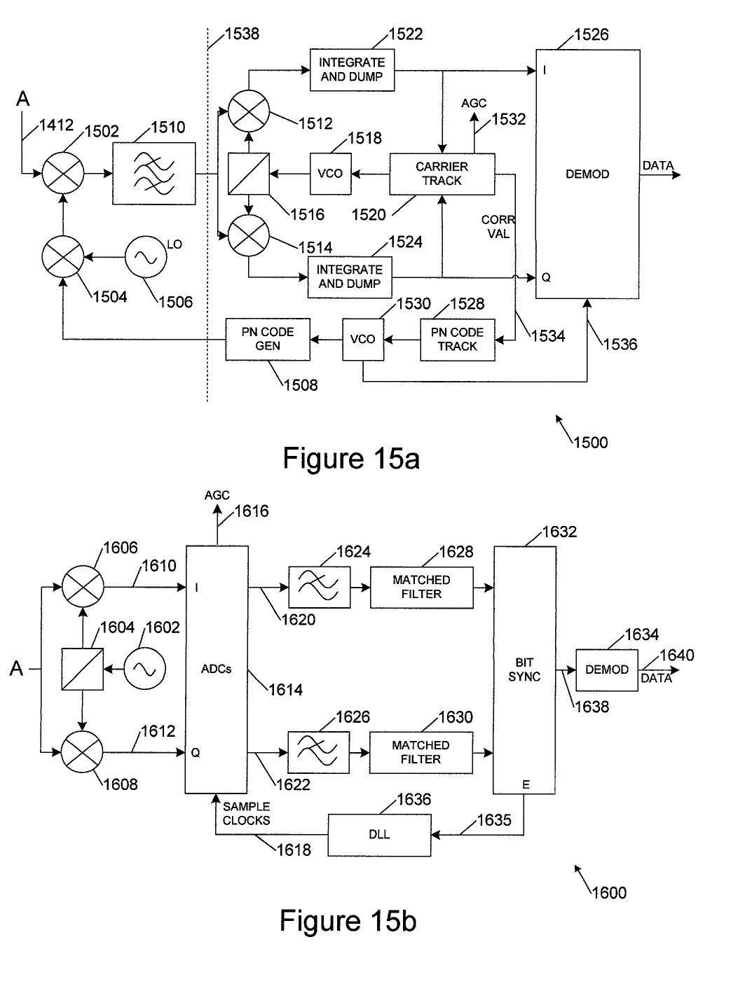

Referring now to FIGS. 14 and 15, these show exemplary spread spectrum receivers for the detector of FIG. 13. The skilled person will be aware that any conventional spread spectrum receiver design could be used for the tag detector, providing that the receiver is suitable for spread spectrum transmission of the type emitted by the tag to be detected. In practice, it is likely that spread spectrum receiver 1300 will be based upon proprietary spread spectrum receiver integrated circuits, to reduce costs, although for reception of more specialised signals, such as those employing Kasami codes, a dedicated receiver design (albeit along conventional lines) may be necessary. For example, a spread spectrum receiver for Gold coded data can be implemented for well under £100 using the SX042 (S20042) and SX061 (S20061) ICs from American Microsystems, Inc. of Pocatello, Id., USA.

FIG. 14 shows an rf front end 1400 for a spread spectrum receiver. This comprises an initial low noise amplifier 1402 followed by one or more IF stages 1404, a bandpass filter 1406 and, optionally, automatic gain control (AGC) circuitry 1408 having an AGC line 1410. The front end provides an output on line 1412.

The output 1412 from the rf front end 1400 may be used to feed a spread spectrum receiver as shown in FIG. 15a or 15b. Referring to FIG. 15a, which shows a conventional spread spectrum receiver design 1500, the input 1412 is mixed in mixer 1502 with the PN spreading code from code generator 1508 mixed with a signal from local oscillator 1506 in mixer 1504. The IF output of mixer 1502 is filtered by bandpass filter 1510. Thus the signal from local oscillator 1506 is BPSK modulated by the PN code and mixed with the incoming signal. If the PN code form generator 1508 has zero relative phase shift to the incoming spreading code there will be a correlation maximum in the mixed output; if the codes are different or not synchronised there will be a low correlation between them. Local oscillator 1506 is optional and input 1412 could be mixed with a “baseband” signal from PN code generator 1508, although this would be likely to introduce an unwanted dc component in the result.

The output of bandpass filter 1510 is mixed with quadrature signals from voltage controlled oscillator (VCO) 1518 and 90° phase splitter 1516. The outputs from mixers 1512 and 1514 are fed to integrate and dump filters 1522 and 1524 respectively and thence to I and Q inputs of demodulator 1526 which demodulates the received (baseband) data and detects preamble and framing bits to output decoded data. Carrier tracking block 1520 receives inputs from the two integrate and dump filters to control VCO 1518. The carrier tracking circuitry also provides an AGC control output 1532 for AGC input 1410 of the receiver front end, to optimise the input on line 1412. The carrier tracking circuitry also provides a correlation value output on line 1534 which has a low level when the PN code generator 1508 is out of lock and a higher level when the code is synchronised to the incoming PN code; this signal can also be used as a measure of received signal strength. The correlation value output is fed to PN code track circuitry which controls VCO 1530 driving the PN code generator 1508. A second output 1536 from VCO 1530 controls data sampling in demodulator 1526.

Conceptually, the code from code generator 1508 slips past the code of the incoming signal until a correlation flash is detected on line 1534. At this point a tau-dither delay lock tracking loop comprising elements 1528, 1530 and 1508 in conjunction with the circuitry from input line 1412 to carrier tracker 1520, maintains the PN code from generator 1508 in synchronism with the received code. The amplitude of the IF output of mixer 1502 is a maximum when the generated code is synchronised to the received code and decreases to a low value when the codes are offset by one code chip or bit.

Frequently the circuitry to the right of dashed line 1538 is implemented digitally, either in software on a digital signal processor (DSP), or in dedicated hardware. In such cases the output from IF bandpass filter 1510 is quadrature sampled by analogue-to-digital converters (A/Ds) to generate digital I and Q signals. AGC output 1532 is then used to optimise incoming signal quantisation. The A/D sampling frequency should be greater than 2fc; in some applications the A/D sampling frequency may be chosen to be an integer multiple of the IF centre frequency to “fold back” the signal to dc.

FIG. 15b shows another example of a digital spread spectrum receiver 1600 in which an input on line 1412 is mixed with quadrature signals from oscillator 1602 and 900 phase splitter 1604 in mixers 1606 and 1608 to generate I and Q signals 1610 and 1612 for A/Ds 1614. The remainder of the processing is done digitally, digital I and Q signals 1620 and 1622 being fed to Nyquist filters 1624 and 1626 and thence to matched filters 1628 and 1630 which are configured to provide a maximum output when the desired PN code input is received. The matched filter outputs feed bit synchronisation circuitry 1632 which provides an error signal 1635 to delay locked loop 1636 which provides sample clocks 1618 to ADCs 1614. The sample clocks are preferably controlled to sample at the mid point of a chip. A second output 1638 from the bit synchronisation circuitry feeds demodulator 1634 to provide a baseband data output 1640.

Both this receiver and the receiver of FIG. 15a are configured for serial code acquisition. Receiver acquisition time, T_{acq}≈4.N_{c}.T_{c}.N_{c} where N_{c} is the number of chips in the spreading sequence and T_{c} the chip period. The factor of 4 arises because the receiver typically slips every other epoch (i.e. complete code sequence) and when it slips, it slips only half a chip period. The final N_{c} arises because all chips in the code are matched before the code slips.

The acquisition time can be adjusted slightly by adjusting loop filter parameters. It can be reduced significantly by performing only a partial correlation before the code slips, for example, if only 10% of the chips are correlated T_{acq} is reduced by a factor of 10. The practicality of this depends upon the codes used and interference. Another strategy for decreasing lock time is to employ a combination of serial and parallel code acquisition by, for example, using more than one pair of matched filters in the arrangement of FIG. 15b, the pairs of matched filters being chosen to respond to codes of different relative phases. Thus, for example, by providing two pairs of matched filters T_{acq} can be halved. To further reduce the acquisition time a synchronisation sequence may be transmitted by the tag on start-up which is detected by a corresponding matched filter in the receiver to provide an approximate initial code lock.

Some examples of system design will now be described. A system suitable for cats and small dogs has a carrier frequency of approximately 2.4 GHz, in the ISM band allocated for spread spectrum transmissions. A chip frequency of f_{c}=127 Kbps drives a Gold code generator with 7 stage shift registers whereby n=7 and N_{c}=127. There are therefore 127 Gold code sequences generated by each preferred pair of taps and there are four preferred pairs: [7,1] and [7,4,3,2]; [7,1] and [7,6,5,2]; and [7,1] and [7,3,2,1]; [7,3,2,1] and [7,6,5,2]. These parameters result in an acquisition time T_{acq}≈0.5 secs.

The preferred pair [7,1] and [7,3,2,1] provides 37 balanced codes and in total the four sets of preferred pairs provide at least 80 balanced codes. This is sufficient for a short range system to ensure that it is unlikely that two tags stimulated simultaneously by a command transmitter have the same spreading code. With 84 balanced codes the chance of three simultaneously transmitting tags having the same code is (83/84).(82/84)=0.96, i.e. there is approximately a 4% chance that two of the tags will share the same spreading code. Eleven tags must be stimulated to transmit simultaneously before there is an even chance that two share a code. This is sufficient codes to ensure an acceptable risk of “collision” for the shorter range command transmitters used with tags for cats and small dogs.

To identify a cat or dog with baseband data. The transmitted data comprises a preamble sequence such as all 1's or all 0's to provide a stable code to which the receiver can lock. The preamble length should approximate to the receiver acquisition time, and thus in the above embodiment would comprise 508 bits. The transmitted tag identity data is framed by start and stop sequences, for example hex codes FC and F0.

A six digit identity code, providing one million differently numbered tags may be contained in three baseband data bytes. This chip rate allows the coded baseband data to be generated by a microcontroller such as a PIC 12C5XX series controller operating at 4 MHz. This provides 32 instruction cycles per chip and each instruction, except for branch instructions, takes a single cycle, allowing a 30 instruction loop. The manufacturers of this device also offer serialised quick-turnaround production programming services in which most data is factory programmed except for a small number of user-defined location for storing an identity number. Furthermore, these devices will operate at 2.5 volts and can be obtained for ˜US$1, in quantity.

The range over which over which a transmission from the above-described tag can be received may be estimated as follows. The null-to-null bandwidth of the DSSS spread spectrum signal is 2f_{c}=254 KHz, and the 3 dB bandwidth 0.88×254 KHz=224 KHz. At 290K the noise power in the receiver, PN=−174+10 log(bandwidth)≈−120 dBm. The processing gain of the receiver, Gₚ=10 log(spread bandwidth/baseband bandwidth), and ≈20 dB. For a 10 dB output signal to noise ratio, 2 dB receiver processing losses (in the tau-dither delay lock loop), and a 4 dB receiver noise figure, the required input signal to noise ratio is −4 dB. Thus the receiver sensitivity is −124 dBm (for an omnidirectional aerial).

Assuming a transmitter output of approximately 1 mW, antenna gain (for a dipole) and coupling losses roughly cancel out so that transmitter ERP ≈1 dBm. Thus a path loss of approximately 123 dB may be tolerated. In free space at 2.4 GHz the path loss is approximately 100 dB at a range of 1 km and changes by 20 dB for a 10:1 range change. The free space range is thus approximately 10 km. In an urban environment, the path loss P_{L}(in dB)≈40+35 log(d in meters) where d is the range. This gives an urban range of approximately 230 m; indoors a range of >100 m is expected. It can be seen that with an acoustic command transmitter the command transmitter range will dominate; the same is not necessarily true in a system with an rf command transmitter and tag command receiver.

A directional Yagi antenna can provide an extra 10-15 dB of gain and for greater range the transmit power may be increased to 5 mW (+7 dBm) and the receiver noise figure reduced to approximately 2 dB. This provides an additional 15-20 dB of tolerable path loss which corresponds to a 100 km line of sight range and a 600-900 m urban range. The processing gain increases by roughly 3 dB for each additional shift register stage so that using a 10 stage shift register (N_{c}=1023) will provide a further 9 dB of processing gain, increasing the urban range to 1.5-2 km.

In a system with a greater range the chance of “collision” between tags having the same spreading code is increased and thus a system employing a greater number of codes is preferable. A system with n=8, N_{c}=255 and f_{c}=511 KHz leaves T_{acq} unchanged. The higher f_{c} can be provided using a 20 MHz PIC device such as a PIC 16C662A-04/SP or a PIC16C715-201, both of which are available at low cost in a 28 pin SOIC package.

This arrangement approximately doubles the number of balanced codes available, as well as providing a 3 dB greater processing gain and thus an improved transmitter range. Gold code preferred pairs for n=8 include [8,6,5,3] and [8,6,5,2]; [8,6,5,2] and [8,7,6,5,2,1]. Longer shift register sequences may be used without compromising the acquisition time by, for example, storing an initial synchronisation sequence for the receiver in the PIC ROM.

Generally speaking there is a trade off between f_{c} and cost, a greater f_{c} requiring a more costly receiver, as well as between f_{c} and number of codes/acquisition time/collision chance. Acquisition time increases as N_{c}² and also varies as 1/f_{c}. Thus with f_{c}=1 MHz and N_{c}=1023 the acquisition time is approximately 4 seconds, although there is 30 dB processing gain, providing the tag with a much greater range, and approximately 1000 balanced codes available. Gold code preferred pairs for n=10 include [10,3] and [10,5,3,2]; [10,3] and [10,9,4,1]. To decrease the acquisition time to a more practical level such as 1 second, f_{c} may be increased to 4 MHz, or four parallel pairs of matched filters may be used in the receiver, or a partial correlation of ˜25% of the code's chips, rather than 100%, may be applied in the code slip loop.

In another embodiment a tag has the same or similar parameters (N_{c}=1023) but employs Kasami codes rather than Gold codes. Thus for n=10, there are approximately 32K codes for each Gold code preferred pair of which 10K are balanced codes. This allows a tag to be identified merely on the basis of its spreading code and there is thus no need to modulate the code with additional baseband data. Likewise, at the detector, there is on need to demodulate baseband data as confirmation that the tag with the desired code has been located is provided by the code lock signal alone. This simplifies both tag and receiver design (and obviates the need for a microcontroller within the tag) as well as reducing the chance of collision between two identical codes. Also the simplified hardware facilitates a higher f_{c} thus more easily providing a practical code acquisition time with longer codes.

A Kasami code-based system is thus particularly advantageous where longer transmit and receive ranges make collisions more likely, such as when tagging larger dogs which can stray considerable distances. Another application where tags with Kasami codes are useful is in lost file location. Generally speaking files are stored in groups and thus transmissions from a plurality of tagged files in roughly the same vicinity are likely to be triggered simultaneously. The use of Kasami codes assists in distinguishing amongst transmissions from such tagged files. As with a tag for pets, a tag for files may use either an acoustic or an rf command receiver.

In one embodiment of a file tracking system a plurality of detectors are networked, using either wireless or wired connections, to a central controller. Such a network may operate over an existing intranet or internet communications system. Physically the detectors are located adjacent groups of files, for example, in a file store and/or in selected rooms and/or in filing cabinets. With such an arrangement a lost file can be localised from the central controller by interrogating each of the detectors either in series or in parallel until the tag with the correct code/identity is located. A manual or detector-assisted search can then be used to identify the precise location of the tagged file. A similar arrangement based on a wide area network (WAN) can be used to determine the approximate location of a lost pet from a central control terminal. In the case of file location a centralised command transmitter may be sufficient for an entire building or the central control unit may send a signal to each detector to transmit a command to its local tags to transmit; this latter arrangement is preferred for locating tagged pets.

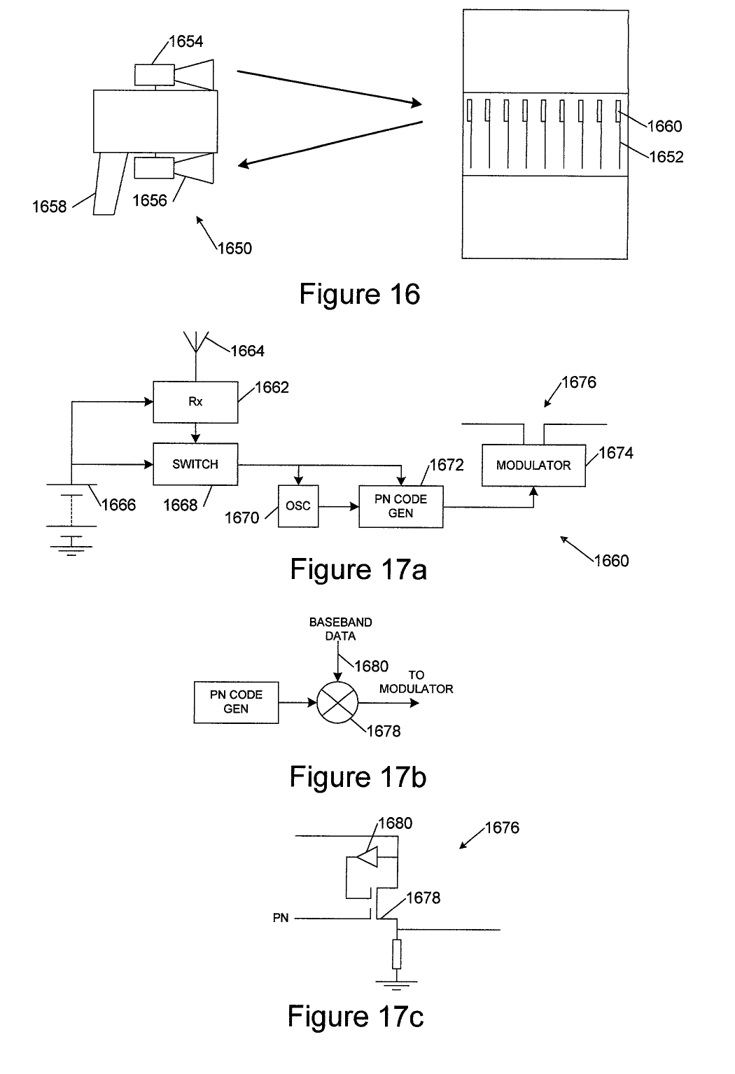

Referring now to FIG. 16, this shows a homodyne radar-based tag detector 1650, in use for locating a tagged file 1652 amongst a plurality of tagged files in a filing cabinet. The detector illuminates the tag 1660 using transmit horn antenna 1654 and receives a modulated spread spectrum return at horn antenna 1656. For isolation the transmit and receive antennas are preferably on opposite sides of the detector and for convenience in use a pistol-type grip 1658 may be provided.

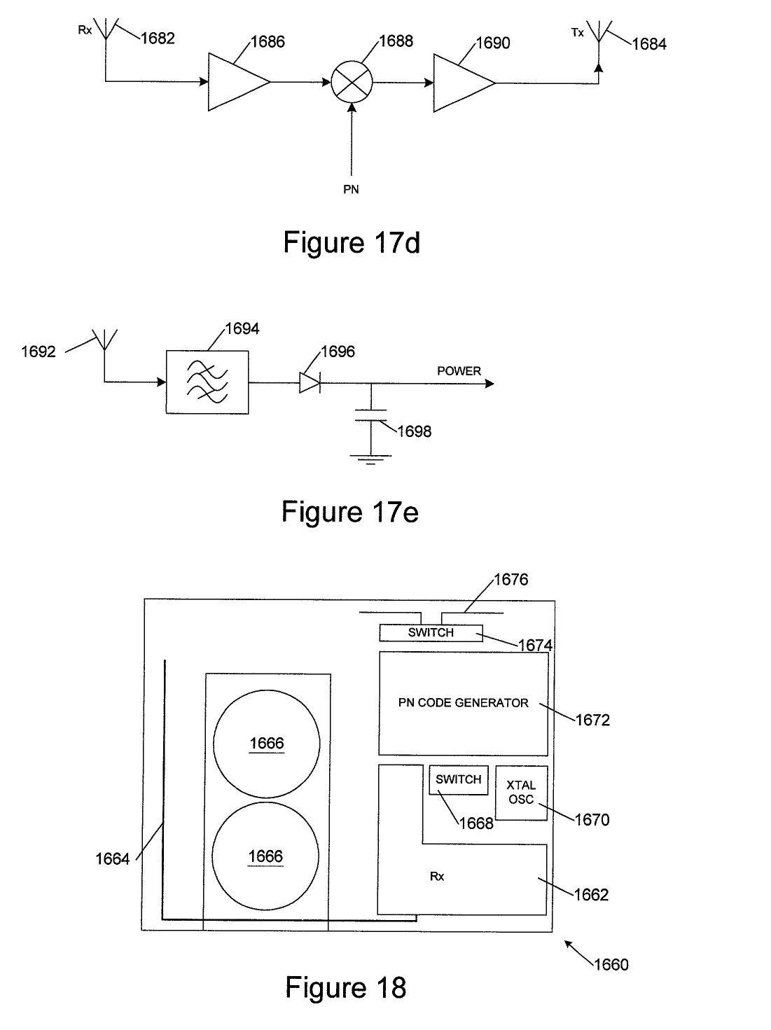

FIG. 17a shows a block diagram of tag 1660. The command receiver 1662 and its antenna 1664, battery 1666, switch 1668, chip oscillator 1670 and PN code generator 1672 are similar to those described earlier with reference to FIGS. 2 to 6. Oscillator 1670 is preferably a crystal oscillator. The PN code generator preferably generates a Kasami code unmodulated by baseband data; oscillator 1670 preferably operates at a high frequency than is preferred for a pet tag, such as f_{c}≧20 MHz, ≧70 MHz, or ≧1100 MHz. Again switch 1668 switches power to oscillator 1670 and PN code generator 1672 and, if necessary, also to modulator 1674. The output of PN code generator 1672 drives modulator 1674 coupled to dipole 1676. This modulates the reflected signal from the radar providing a spread spectrum coded return signal.

Use of a higher f_{c} allows longer code sequences for a given acquisition time and hence a greater number of different codes, reducing the collision risk. This is important as it may be necessary to distinguish amongst 10,000 or 100,000 different files stored in large groups. The increased processing gain is also helpful in a radar system where the return signal is often very low level.

FIG. 17b shows an alternative embodiment in which the output of code generator 1672 is mixed with baseband data 1680 in mixer 1678 before input to modulator 1674; this allows baseband data to be modulated onto the radar return if desired. As before, the code and baseband data are preferably synchronised.

FIGS. 17c and d show, conceptually, methods for phase modulation of the code onto the radar return. In FIG. 17c the incoming signal incident on the tag is mixed with the PN code in dual-gate FET 1678 which drives one arm of dipole 1676 (biasing is not shown). Amplifier 1680 is arranged to drive one gate of FET 1678 with a signal in phase with the incoming radiation.

In FIG. 17d dipole 1676 is replaced by separate receive 1682 and “transmit” 1684 antennas. The incoming radar signal is amplified in amplifier 1686, mixed with the PN code in mixer 1688 and fed via amplifier 1690 to transmit antenna 1684 which provides a radar return signal.

FIGS. 17c and d are intended to provide phase modulation of the radar return. For amplitude modulation of the radar return modulator 1674 may simply present a changing load to dipole antennas 1676 and may comprise, for example, a switch which shorts or leaves open circuit dipole arms 1676, according to whether the output of the PN code generator is a one or a zero.

The tag of FIG. 17a may be self-powered, in which case battery 1666, receiver 1662, antenna 1664 and switch 1668 are no longer needed. In a self-powered embodiment power is derived from the incident rf signal from the interrogating radar, as shown conceptually in FIG. 17e. Here receive antenna 1692 and (optional) bandpass filter 1694 collect rf energy from the incident radar radiation for rectification by diode 1696, preferably a low-bias Schottky diode, and smoothing by capacitor 1698, to provide an approximate dc power output to the tag oscillator and code generator. Since only limited power is available, depending upon the level of received energy from the rf radar transmission it may not be practical to use a crystal oscillator for oscillator 1670 and an alternative, lower power oscillator, such as a CMOS RC oscillator may be preferred.

FIG. 18 shows a physical embodiment of the tag of FIG. 17a, using the same reference numerals. The tag has a broad, low-profile configuration for secure attachment to a file and to reduce interference with physically adjacent files. Likewise batteries 1666 preferably have a low height.

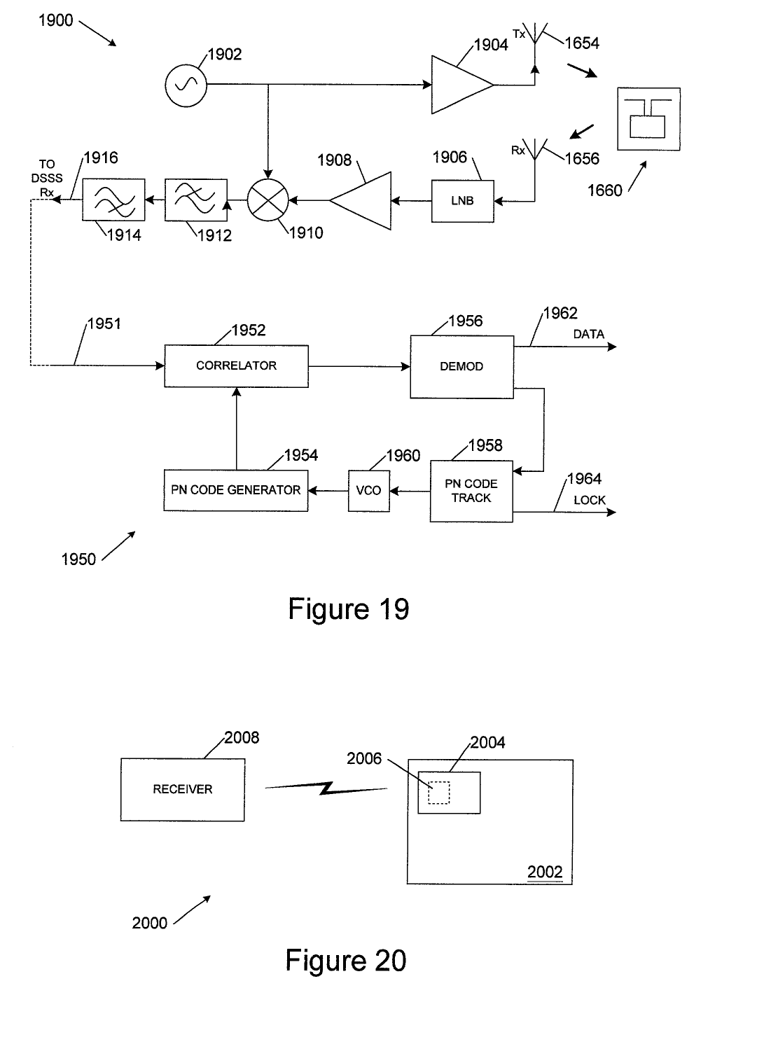

FIG. 19 shows a radar detector for the tag of FIGS. 17 and 18. FIG. 19a shows a homodyne radar front end 1900 and FIG. 19b shows a spread spectrum receiver 1950 to which it is coupled. In FIG. 19a an unmodulated rf carrier is generated by oscillator 1902, in an exemplary embodiment at 10.7 GHz, and amplified by power amplifier 1904 before transmission by antenna 1654. Antenna 1654 is preferably a high gain, directional antenna such as a horn antenna; an antenna with open end dimension of 3λ by 3λ/2 (where λ is the wavelength of the rf carrier) provides a gain of 16.5 dBi, and at 10.7 GHz, λ/2≈1.4 cm.

The return signal from tag 1660 is received at antenna 1656, preferably a high gain horn antenna, amplified by low noise block downconverter 1906 and low noise preamplifier 1908 before being mixed with the original carrier from oscillator 1902 in mixer 1910. The output of mixer 1910, which is at baseband, is low-pass filtered by filter 1912, which rolls off at approximately f_{c}, and is high-pass filtered by filter 1914 to remove the large dc component produced by unmodulated carrier. The spectrum of a spread spectrum signal is a line spectrum with spacing f_{c}/N_{c} and filter 1914 should have a sharp roll-off below the lowest frequency component in the spread return. The spread spectrum coded signal, at dc, is provided on output 1916.

The output of the radar front end may be fed to a conventional DSSS receiver if tag 1660 provides a phase modulated return. Since the output 1916 is at dc in-phase and quadrature sampling of the signal is necessary to identify positive and negative frequency components. Since phase modulation by tag 1660 is relatively inefficient, it is more likely that in a practical system the spread system code is amplitude modulated onto the radar return. In this case a simplified receiver design, such as is outlined in FIG. 19b, may be used with AM detection, to correlate with the received code and/or recover any baseband data.

In FIG. 19b input 1951 is coupled to output 1916 of the rf front end and provides a first input to correlator 1952. The correlator has a second input from PN code generator 1954 and, conceptually, the PN code from generator 1954 is controlled to slip past the code modulating the radar return until a correlation flash is identified, when the code generator 1954 is locked to the input code. This is achieved by demodulator 1956, code tracking circuitry 1958 and code VCO 1960. An output 1964 from tracking circuitry 1958 indicates code lock and, if necessary, baseband data is provided on output 1962 from demodulator 1956. Preferably receiver 1950 is implemented digitally, either in hardware, or in software on a DSP; in this case, output 1916 of rf front end 1900 is digitised by one or more analogue to digital converters, if necessary controlled to take account of any residual dc offset.

A homodyne radar-based system is particularly practical for file location because in general only short range tag detection is required and hence a low level return signal can be tolerated. Use of a homodyne radar removed the need for an rf carrier oscillator in the tag and may allow the illuminating radiation to be used as the tag's power source, thus providing smaller and cheaper tags. A cheap embodiment of a tag uses the parameters outlined above for file tagging (N_{c}=1023, f_{c}˜4-6 MHz for T_{acq}≈1-0.7 seconds). The command receiver may be acoustic or rf (at its simplest, a tuned circuit for carrier detection).

In a second embodiment a tag for locating files has a Kasami PN code generator based on 12-stage shift registers (n=12, N_{c}=4095, 256K codes). This provides ˜10⁵ balanced codes for tagging large numbers of files with a low risk of collision and without the need for baseband identity data; this also provides a processing gain of ˜36 dB. At f_{c}˜70 MHz, T_{acq}˜1 second; at f_{c}˜100 MHz, T_{acq}˜0.7 seconds. For a low cost Kasami code generator operating at 70 MHz may be provided by a field programmable gate array (FPGA) such as an XC3020 from Xilinx; when operating at higher frequencies an AT60XX from Atmel may be used. At 70 MHz the spread spectrum line spacing is 17 KHz, at 100 MHz it is approximately 24 KHz and the high pass filter 1914 of the rf front end should be chosen to roll off steeply below these frequencies, as appropriate.

Embodiments of a system for alerting a user to separation from a tagged object will now be described with reference to FIGS. 20 to 23.

Referring to FIG. 20, this shows a system 2000 comprising a tagged object 2002 and a receiver 2008 for alerting a user to impending loss of the object. The tagged object may comprise an article such as a briefcase, laptop computer or the like, or an animate object such as a pet or child. A tag 2004 is attached to the object either temporarily or permanently. For example in the case of a briefcase the tag may be fastened to the case or installed in the lining, in the case of a laptop the tag may be installed in a PCMCIA slot, and in the case of a pet or child the tag may be attachied to a collar or ankle band.

The tag has a manually-operated switch 2006, for switching transmissions from the tag on and off. Where a discrete switch is desirable this may comprise, for example, a capacitatively operated switch or a magnetically operated switch such as a reed or Hall effect switch. In FIG. 20 numeral 2006 indicates the plate of a capacitatively operated switch.

A receiver 2008 is in radio contact with the tag to alert the user when the tag goes out of range. Typically this receiver is carried by the owner or guardian of the tagged object.

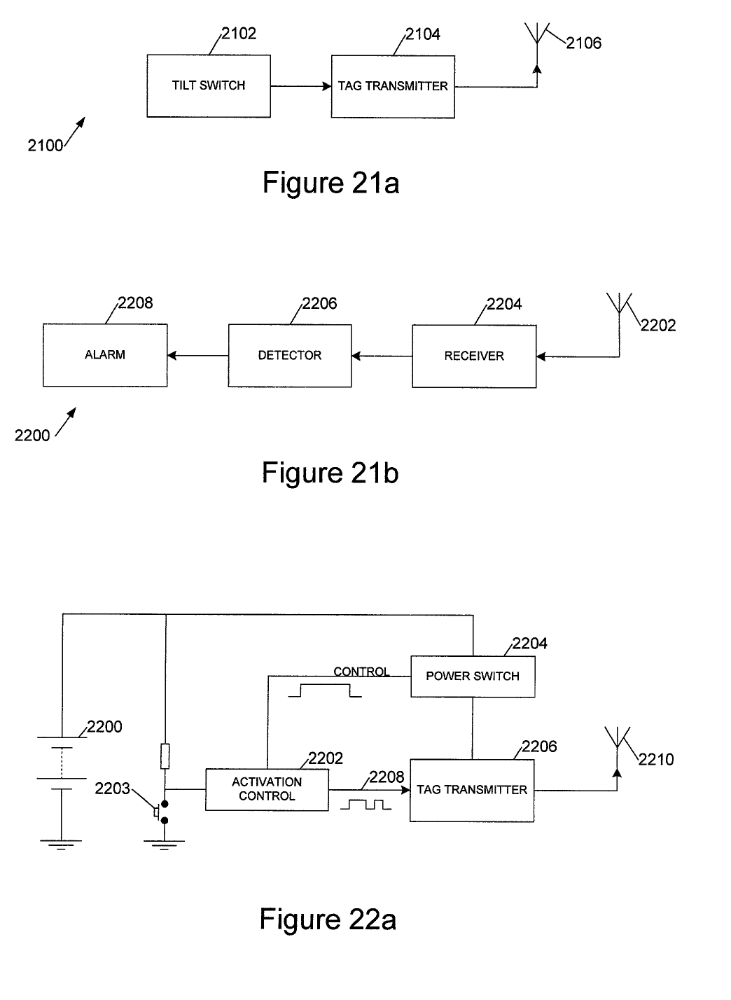

Referring now to FIG. 21a a tag 2100 comprises a mercury tilt switch 2102 coupled to a tag transmitter 2104 which in turn feeds a tag antenna 2106 for transmitting to a tag receiver. The tilt switch is arranged so that the tag is activated when the tagged object is in a suitable resting orientation, such as horizontal for a briefcase. For a laptop the tilt switch may be installed in the screen so that the tag is active when the laptop is resting horizontally, but not in use (ie. when the screen is folded flat).

FIG. 21b shows a tag receiver 2200 comprising a receiver antenna 2202, a receiver 2204 to receive transmissions from tag 2100, a detector 2206 to detect reception of a deactivation signal from the tag and an alarm 2208 to alert a user of the system when the received signal strength of transmissions from the tag fall below a preset threshold without the deactivation signal having been received. Preferably the alarm alerts only the user, and a pager or mobile phone vibrator is suitable.

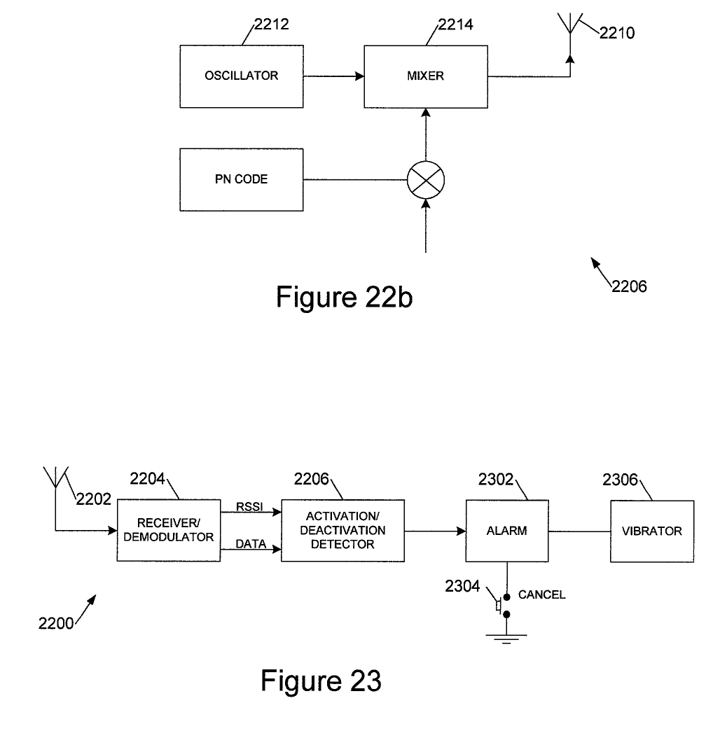

FIG. 22a shows a block diagram of a tag in more detail. A power source 2200 comprises a small battery such as a button cell and a tag activation control circuit 2202 is permanently powered and thus preferably comprises low power, eg CMOS, circuitry. A push button 2204 is coupled to activation control 2202 for activating and deactivating the tag, eg. with one or two pushes. Activation control circuit 2202 controls a power switch 2204, eg. a MOSFET, which switches power to a transmitter 2206. The control circuit 2202 controls switch 2204 to begin and cease transmissions.

A data line 2208 from control circuit 2202 provides a data input to transmitter 2206 which provides a modulated transmit output signal to antenna 2210. The data line 2208 is used to modulate the transmitter output with the deactivation signal. In other embodiments the transmitter is modulates by switching its power with switch 2204.

When push button 2204 is used to activate the transmitter control circuit 2202 operates to switch on power to transmitter 2206 but data line 2208 is held at a constant level, eg logic 0 or 1. When button 2204 is operated to deactivate the transmitter control circuit 2202 first outputs a deactivation signal on line 2208 which modulates the transmitter output, and then controls power switch 2204 to switch off the transmitter.

FIG. 22b shows transmitter 2206 in more detail. The transmitter comprises an oscillator 2212 which generates an rf carrier which is provided to a first terminal of a mixer 2214, the output of which is coupled to transmit antenna 2210. A PN code generator 2216 generates a spread spectrum spreading code which is combined with data on line in mixer (multiplier) 2218. The output of mixer (multiplier) 2218 thus comprises a PN spreading code modulated by the data input, and this is fed to a second terminal of mixer 2214, which thus generates a DSSS output.

The output of the PN code generator 2216 is arranged to move between binary signal levels of +1 and −1 so that when mixed with the output of oscillator 2212 a binary phase shift keyed (BPSK) signal is provided to antenna 2210. Mixer 2214 is preferably a balanced mixer and may be constructed from a dual-gate FET or from a differential amplifier. Other forms of modulation such as differential BPSK and CPSM (continuous phase shift modulation) can also be used.

Oscillator 2212 is preferably physically small and has a relatively low current consumption and power output. In general oscillator 2212 may operate at any frequency, although the frequency should be high enough to allow modulation of the PN code sequence onto the carrier without excessive spectrum occupancy. In the UK the ISM (Industrial, Scientific and Medical) frequency band of 2.4-2.4835 GHz is explicitly designated for spread spectrum transmissions provided these have an EIRP of less than 10 mW per 1 MHz of spectrum occupancy. In the US additional frequency bands of 903-928 MHz and 5.725-5.85 GHz are also available for spread spectrum devices.

In a preferred embodiment oscillator 2212 operates at about 2.4 GHz and provides an output power in the range 0.1 dBm to 1 dBm. A small, low-power oscillator for these frequencies can be constructed using a ceramic resonator or a stub comprising a resonant length of solid coax. Mixer 2214 preferably incorporates a buffer and impedance matching circuitry to optimise its coupling to antenna 2210. Since a 1 dBm transmitter output is sufficient to provide the necessary range, no amplification is necessary for this application. (Where longer ranges are required, a monolithic microwave integrated circuit (MMIC) can be employed to boost the transmitted output to around 10 dBm). A PN code generator 2216 generates a pseudonoise spreading code for spread spectrum use, such as is known to those skilled in the art and as is described above with reference to FIG. 5.

The spread spectrum transmitter 2206 preferably uses a relatively short spreading sequence, which simplifies the system design and provides higher baseband data rates. This permits the deactivation control signal to be shorter and thus allows faster tag deactivation. A short spreading sequence also reduced the spread spectrum processing gain, which is desirable since the tag range is preferably relatively short, or example, between 1 m and 10 m. Gold codes as described above may be used for distinguishing between signals simultaneously transmitted from multiple tags.

FIG. 23 shows the receiver 2200 of FIG. 21b in more detail. Receiver 2204 comprises a DSSS receiver of a conventional design. Such a receiver can, for example, be implemented cheaply using the SX042 and SX061 ICs available from American Microsystems, Inc. of Pocatello, Id., USA, in conjunction with a microcontroller (not shown in FIG. 3).

The activation/deactivation detector 2206 is coupled to a baseband output of receiver 2204 and to a received signal strength indication (RSSI) output of the receiver. Detector 2206 operates to provide an output to alarm device 2302 when the RSSI falls below a threshold value without the deactivation signal having been received on the data input from receiver 2204. The alarm device 2302 preferably incorporates a button 2304 to cancel the alarm, and drives a vibrator 2306. In practice detector 2206 and alarm 2302 are preferably implemented on software running on a microcontroller which also controls the proprietary ICs of spread spectrum receiver 2204 to write setup data into configuration registers, provide control functions, and receive data outputs from the spread spectrum decode ICs, and the like.

In some embodiments the alarm circuitry 2302 may also be configured to send a signal to a mobile communications network, for example to send a signal to a pager or an SMS text message to a GSM mobile phone.

In an alternative, simplified embodiment activation control circuit 2202 may be dispensed with. In such an embodiment the tag transmitter may be switched on and off with a simple manually-operated switch and the receiver switched on after the transmitter is switched on (and off before the transmitter is switched off). Such a manual switch may comprise, for example, a slide or push-button switch or a capacitatively operated switch or a magnetically operated switch such as a reed or Hall effect switch. The receiver preferably still provides a warning when the tag goes out of range, for example, when the tag is greater than a predetermined or set range from the receiver.

This embodiment may be used by attaching the tag to an object or valuable, or pet or child, and then switching the tag on at an appropriate moment, for example when the pet is let out or, for a tagged briefcase, after taking a seat on a train. The receiver then alerts the uses when the tagged object, pet or child goes out of range.

In this simplified embodiment the receiver may be similar to a pager receiver, with an internal or external aerial and a visible and/or audible warning to indicate that the tag is out of range. In a more sophisticated receiver one or more of the following optional features may also be provided: (i) an adjustable (warning) range; (ii) a received signal strength indicator; and (iii) a directional antenna and means for selecting either a standard (less directional) antenna or the directional antenna. These features assist in using the receiver to search for a tagged object that has been lost.

The receiver warning device may comprise any of the above described alarm devices, Likewise the tag switch may incorporate any of the above described switching arrangements such as, for example, a slide switch, a push button, a tilt switch, or a capacitatively or magnetically operated switch.

This embodiments of FIGS. 20 to 23 have been described in the context of a DSSS transmitter but other spread spectrum transmissions may also be used, such as frequency hopping spread spectrum transmissions. Where desirable the transmissions in systems for helping to prevent item loss may be better concealed if they are arranged to look like or emulate Bluetooth (Trade Mark) transmissions. Where minimising costs is important a simplified arrangement using AM (amplitude modulated) transmissions modulated by short pulses can be employed, although preferably at sufficiently low power to avoid the need for radiocommunications licensing.

All the tags have been described mainly in connection with direct sequence spread spectrum transmissions but a frequency hopping spread spectrum transmitter, such as the GJRF-01 IC from Gran-Jansen, Oslo, Norway, can also be used in any of the above-described tag and receiver systems.

No doubt many other effective alternatives will occur to the skilled person and it should be understood that the invention is not limited to the described embodiments and encompasses modifications apparent to those skilled in the art lying within the spirit and scope of the claims appended hereto.

I claim:

1. A pet tag, the tag comprising:
a housing configured for attaching the tag to a pet;
an internal power supply contained within said housing; and
a spread spectrum transmitter contained within said housing;
wherein said spread spectrum transmitter has a transmit power substantially equal to or less than 1000 μW.

2. A pet tag as claimed in claim 1 wherein said spread spectrum transmitter has a transmit power substantially equal to or less than 200 μW.

3. A pet tag as claimed in claim 1 wherein said spread spectrum transmitter has a spreading code length equal to or greater than 2⁴−1 bits.

4. A pet tag as claimed in claim 1 wherein said spread spectrum transmitter is a direct sequence spread spectrum transmitter.

5. A pet tag as claimed in claim 1 wherein said spread spectrum transmitter is permanently connected to said internal power supply.

6. A pet tag as claimed in claim 1 wherein the supply of power from said internal power supply to said spread spectrum transmitter is controlled by a manually-operated switch.

7. A pet tag as claimed in claim 1 wherein the output of said spread spectrum transmitter is pulsed, the pulses having an on state when said transmitter is transmitting a spread spectrum signal and an off state when said transmitter is not transmitting.

8. A tag for locating an object, the tag comprising:
an rf transmitter to transmit a coded signal; and
an acoustic command receiver to receive an acoustic command; and
wherein the coded signal is transmitted in response to reception of an acoustic command.

9. A tag as claimed in claim 8 wherein the coded signal is a spread spectrum signal having a spreading sequence code.

10. A tag as claimed in claim 9 wherein the rf transmitter is a direct sequence spread spectrum transmitter.

11. A tag as claimed in claim 10 wherein the spreading sequence comprises a Gold code.

12. A tag as claimed in claim 10 wherein the spreading sequence comprises a Kasami code.

13. A tag as claimed in claim 9 wherein the length of the spreading sequence is ≦2¹⁰−1 chips, and preferably ≦2⁸−1 chips.

14. A tag as claimed in claim 9 wherein the spread spectrum signal comprises the spreading sequence code modulated by baseband data.

15. A tag as claimed in claim 14 wherein a tag identity comprises a combination of the spreading sequence code and the baseband data.

16. A tag as claimed in claim 12 wherein the spreading sequence code is unmodulated by baseband data.

17. A tag as claimed in claim 16 wherein the length of the spreading sequence is ≦2¹²−1 chips, and preferably ≦2¹⁰−1 chips.

18. A tag as claimed in claim 8 wherein the command receiver is configured to control a power supply to at least part of the tag.

19. A tag as claimed in claim 18 wherein the command receiver controls a power supply to the transmitter for transmitting the coded signal and for ending the transmission after a time interval, or on cessation of the command, or on receipt of a stop command.

20. A tag as claimed in claim 8 wherein the command receiver is responsive to acoustic commands at a frequency of ≧5 KHz, preferably ≧10 KHz, more preferably ≧15 KHz, still more preferably ≧17 KHz, and most preferably ≧20 KHz.

21. A tag as claimed in claim 8 wherein the command receiver is responsive to acoustic commands which are substantially inaudible to most adult humans.

22. A tag as claimed in claim 8 wherein the command receiver comprises an acoustic transducer coupled to a tone detector.

23. A tag for locating an object, the tag comprising:
a command receiver to receive a command; and
a spread spectrum rf transmitter, the spread spectrum transmitter having a spreading code;
wherein the transmitter transmits a spread spectrum signal responsive to a received command; and
wherein the transmitted signal conveys the spreading code unmodulated by baseband data.

24. A tag as claimed in claim 23 wherein identity data for the tag consists of the spread spectrum spreading code.

25. A tag as claimed in claim 23 wherein the tag transmits only the spreading code.

26. A tag as claimed in claim 23 wherein the spreading code comprises a Gold code.

27. A tag as claimed in claim 23 wherein the spreading code comprises a Kasami code.

28. A tag as claimed in claim 23 wherein the transmitter is a direct sequence spread spectrum transmitter.

29. A tag as claimed in claim 23 wherein the length of the spreading sequence is ≦2¹⁴−1,and preferably ≦2¹²−1.

30. A tag as claimed in claim 23 wherein the command receiver includes an acoustic transducer and is responsive to acoustic commands.

31. A tag as claimed in claim 30 wherein the command receiver is responsive to acoustic commands which are substantially inaudible to adult humans.

32. A tag as claimed in claim 23 wherein the command receiver controls a power supply to the transmitter to switch transmission on.

33. A tag as claimed in claim 32 further comprising means to switch transmission off after a predetermined interval.

34. A tag as claimed in claim 8 further comprising means to collect and store solar power.

35. A tag as claimed in claim 8 further comprising a battery for powering the tag, and a battery monitor for indicating when battery power is low.

36. A tag as claimed in claim 35 wherein the battery monitor comprises an indicator with an on-off duty cycle in which the on period is less than the off period.

37. A tag as claimed in claim 35 wherein the battery monitor is configured to periodically put the battery under load to test the battery.

38. A detector for locating an object having a tag, the detector comprising:
a direct sequence spread spectrum (DSSS) receiver for receiving from the tag a spread spectrum signal based on a Gold or Kasami code;
a first aerial coupled to the receiver;
input means for user selection of a said Gold or Kasami code; and
indicating means for indicating when a tag with the selected code is detected.

39. A detector as claimed in claim 38 further comprising input means for user input of tag identity data and wherein the or another indicating means indicates when a tag with both the selected code and the user-input tag identity is detected.

40. A detector as claimed in claim 39 further comprising means to indicate when a tag with the selected code and identity data different to the user-input tag identity is detected.

41. A detector as claimed in claim 38 wherein the DSSS receiver is configured to receive a spread spectrum signal unmodulated by baseband data and wherein a tag for detection is identified by said unmodulated Gold or Kasami code.

42. A detector as claimed in claim 38 further comprising a second aerial, the first and second aerials having different directionality, and means for selectively coupling either the first or the second aerial to the receiver.

43. A detector as claimed in claim 38 further comprising an acoustic transducer and means coupled to the acoustic transducer to indicate the issue of an acoustic command signal for commanding a tag.

44. A detector as claimed in claim 38 further comprising means to issue an acoustic command signal to a tag.

45. A detector as claimed in claim 38 further comprising means to issue an rf command signal to a tag.

46. A detector as claimed in claim 38 wherein the detector comprises control means for searching or indicating a search for the tagged object substantially only when a tag is likely to be transmitting.

47. A detector as claimed in claim 38 further comprising test transmission means for transmitting a test transmission for testing operation of the detector.

48. A tag for use with a tag detector radar, the tag comprising:
a pseudonoise (PN) code generator for generating a spreading code for a spread spectrum system; and
a modulator and antenna combination for providing a modulated radar return from the tag;
wherein the PN code generator is coupled to the modulator for modulating the radar return with the spreading code.

49. A tag as claimed in claim 48 wherein the modulator comprises means to phase modulate the spreading code onto the radar return.

50. A tag as claimed in claim 48 comprising mixing means to mix an incident radar signal with the PN code to modulate the spreading code onto the radar return.

51. A tag as claimed in claim 48 wherein the modulator comprises amplitude modulation means to amplitude modulate the spreading code onto the radar return.

52. A tag as claimed in claim 48 wherein the modulator comprises switch means coupled to the code generator and to the antenna to modulate the radar return with the spreading code.

53. A tag as claimed in claim 52 wherein the antenna approximates a dipole and wherein the switch means is coupled between arms of the dipole.

54. A tag as claimed in claim 48 wherein the code is selected from an m-sequence and/or a Gold code and/or a Kasami code.

55. A tag as claimed in claim 48 further comprising means to modulate the PN code with baseband data.

56. A tag as claimed in claim 48 further comprising a command receiver to control operation of the PN code generator and/or modulator.

57. A tag as claimed in claim 48 further comprising means to at least partially power the tag using incident radar radiation.

58. A set of tags each as claimed in claim 48, each having a spreading code with a high autocorrelation coefficient and a low cross-correlation coefficient with the codes of other tags in the set.

59. A radar detector for a tag providing a radar return modulated with a spread spectrum code, the detector comprising a radar front end coupled to a spread spectrum receiver.

60. A radar detector as claimed in claim 59 wherein the radar is a homodyne radar.

61. A radar detector as claimed in claim 59 wherein the receiver is adapted for reception of a phase modulated spread spectrum signal.

62. A radar detector as claimed in claim 59 wherein the receiver is adapted for reception of an amplitude modulated return signal

63. A network comprising a plurality of tag detectors, each as claimed in claim 59 coupled to a central control unit for providing an approximate tag location.

64. A system for alerting a user having a tag receiver to separation from a tagged object, the system comprising a tag and a tag receiver, the tag comprising:
an activation/deactivation control device; and
a transmitter coupled to the control device; the tag being configured to:
upon activation, start transmitting; and
upon deactivation, transmit a deactivation signal and cease transmitting; the tag receiver comprising:
a receiver for receiving transmissions from the tag;
a detector, coupled to the receiver, for detecting a reduction in the strength of signal received from the tag and for detecting reception of the deactivation signal from the tag; and
an alarm device, coupled to the detector, for providing a user alert when a reduction in signal strength is detected without a deactivation signal.

65. A system as claimed in claim 64 wherein the deactivation signal comprises at least one pulse.

66. A system as claimed in claim 64 wherein said detector detects a reduction to a threshold level in the strength of signal received from the tag.

67. A system as claimed in claim 64 wherein said detector detects a rate of reduction in the strength of signal received from the tag.

68. A system as claimed in claim 64 wherein the tag is a radio frequency tag providing an rf output modulated by a baseband signal comprising at least the deactivation signal, and wherein the half power bandwidth of the rf output is at least ten times the half power bandwidth of the baseband signal.

69. A system as claimed in claim 64 wherein the tag transmitter is a spread spectrum transmitter.

70. A system as claimed in claim 69 wherein the spread spectrum transmitter is a direct sequence spread spectrum transmitter.

71. A system as claimed in claim 69 wherein the spread spectrum transmitter is a frequency hopping spread spectrum transmitter.

72. A system as claimed in claim 71 wherein the frequency hopping spread spectrum transmitter operates substantially consistently with at least version 1.0 of the Bluetooth standard.

73. A system as claimed in claim 64 wherein the transmitter, when activated, transmits an rf signal modulated by a tone.

74. A system as claimed in claim 64 wherein the control device comprises an orientation-operated switch.

75. A system for alerting a user having a tag receiver to separation from a tagged object, the system comprising a tag and a tag receiver, the tag comprising:
a spread spectrum transmitter; and
a switch coupled to the spread spectrum transmitter for switching the spread spectrum transmitter on and off; the tag receiver comprising:
a receiver for receiving transmissions from the tag;
a detector, coupled to the receiver, for detecting a reduction in the strength of signal received from the tag; and
an alarm device, coupled to the detector, for providing a user alert when a reduction in signal strength is detected.

76. A system as claimed in claim 75 wherein the spread spectrum transmitter is a direct sequence spread spectrum transmitter.

77. A system as claimed in claim 76 wherein the receiver has a first receiving antenna and one or more additional features selected from (i) an adjustable range; (ii) a received signal strength indicator; and (iii) a second, directional receiving antenna and means for selecting one of said first and second receiving antennas
